(19) United States
(12) Patent Application Publication
(10) Pub. No.: US 2026/0230738 A1
(43) Pub. Date: Aug. 6, 2026

(54) EARPHONES

(71) Applicant: SHENZHEN SHOKZ CO., LTD., Shenzhen (CN)

(72) Inventors: Burui GUO, Shenzhen (CN); Zhiqing LIU CHUN, Shenzhen (CN)

(73) Assignee: SHENZHEN SHOKZ CO., LTD., Shenzhen (CN)

(21) Appl. No.: 19/637,143

(22) Filed: Apr. 2, 2026

Related U.S. Application Data
(63) Continuation of application No. PCT/CN2025/092663, filed on Apr. 30, 2025.

(30) Foreign Application Priority Data
Dec. 15, 2024 (CN) 202411844133.7

(51) Int. Cl. H04R 1/10

(52) U.S. Cl. CPC H04R 1/1016; H04R 1/105; H04R 1/1066

(57) ABSTRACT

Disclosed is an earphone including: a flexible portion, a housing portion, an earhook portion, and a speaker. In a wearing state, the housing portion includes an inner face facing a user, an outer face away from the user, and a side face connecting the inner face and the outer face. The flexible portion is located on the side face. A small portion of the flexible portion abuts against the cavum conchae wall in the wearing state of the earphone. The flexible portion is a soft structure with elasticity, which deforms relative to the cavum conchae wall under a wearing pressure, increases an area abutting against the cavum conchae wall, reduces a pressure of the earphone squeezing the cavum conchae wall, thereby improving the wearing comfort. Furthermore, the elastic deformation of the flexible portion also adapts to the cavum conchae of different shapes and sizes for different populations.

### CROSS-REFERENCE TO RELATED APPLICATIONS

This application is a continuation of International Application No. PCT/CN2025/092663 filed on Apr. 30, 2025, which claims priority to Chinese Patent Application No. 202411844133.7 filed on Dec. 15, 2024, the entire contents of which are incorporated herein by reference.

### TECHNICAL FIELD

The present disclosure generally relates to a field of acoustic technology, and in particular, to an earphone.

### BACKGROUND

Earphones have become indispensable tools in people's daily life and work. The earphones may be used with terminal devices such as mobile phones and computers to provide users with an auditory feast. As user requirements for the earphones continue to increase, in addition to a stable output performance, a wearing comfort of the earphone is also one of important factors affecting the user experience of the earphone.

### SUMMARY

One or more embodiments of the present disclosure provide an earphone for improving a wearing comfort of the earphone.

In one embodiment, an earphone is provided. The earphone includes a flexible portion, a housing portion, an earhook portion, and a speaker. The housing portion has an accommodation cavity. The speaker is disposed in the accommodation cavity. The flexible portion is connected to one end of the housing portion, and the earhook portion is connected to the other end of the housing portion; and the earphone includes an inner face facing a user, an outer face facing away from the user in a wearing state, and a side face connecting the inner face and the outer face. The flexible portion is located at the side face, and at least a portion of the flexible portion abuts against a cavum conchae wall in the wearing state.

In one embodiment, the housing portion has a long axis direction, a short axis direction, and a thickness direction perpendicular to each other, the thickness direction being parallel to a vibration direction of the speaker. The flexible portion is disposed at one end of the housing portion in the long axis direction, and the earhook portion is connected to the other end of the housing portion in the long axis direction away from the flexible portion; a first gap space communicating with an external ear canal is formed between an upper side of the housing portion and the cavum conchae wall in the wearing state, and a second gap space communicating with the external ear canal is formed between a lower side of the housing portion and the cavum conchae wall in the wearing state. The first gap space and the second gap space are respectively located on two sides of the housing portion in the short axis direction.

In one embodiment, a central axis plane of the flexible portion in the thickness direction coincides with a central axis plane of the housing portion in the thickness direction.

In one embodiment, the flexible portion only includes a first flexible section. The first flexible section is connected to the end of the housing portion in the long axis direction.

In one embodiment, the flexible portion includes a first flexible section and a second flexible section connected to each other. The first flexible section is connected to the end of the housing portion in the long axis direction; and the second flexible section is connected to an upper wall of the housing portion in the short axis direction upward in the wearing state.

In one embodiment, one end of the first flexible section extends to be aligned or flush with a lower wall of the housing portion in the short axis direction downward in the wearing state.

In one embodiment, a length of the second flexible section is less than or equal to half of a length of the housing portion in the short axis direction.

In one embodiment, the second flexible section includes a first portion close to the first flexible section and a second portion away from the first flexible section. In the wearing state, the first portion abuts against the cavum conchae wall, and a gap is formed between the second portion and the cavum conchae wall.

In one embodiment, the second portion is provided with a mounting cavity and a sound pickup hole. The mounting cavity is in communication with an outside of the earphone through the sound pickup hole, and a sound pickup device is installed in the mounting cavity.

In one embodiment, the first flexible section and the second flexible section are an integrated structure; and/or the first flexible section and the second flexible section are connected to form a C-shaped structure or an L-shaped structure.

In one embodiment, the housing portion includes an inner wall facing an ear, an outer wall facing away from the ear, an upper wall facing upward, and a lower wall facing downward in the wearing state along the vibration direction of the speaker. An outer surface of the flexible portion protrudes from the upper wall and/or the lower wall of the housing portion; and/or the outer surface of the flexible portion is not coplanar with the inner wall and/or the outer wall of the housing portion.

In one embodiment, the flexible portion at least includes a contact layer, wherein a Shore hardness of the contact layer is less than a Shore hardness of the housing portion, and at least a portion of the contact layer abuts against the cavum conchae wall in the wearing state.

In one embodiment, the flexible portion further includes a lining layer. The contact layer wraps an outer side of the lining layer; the lining layer is connected to the housing portion; and the Shore hardness of the contact layer is less than a Shore hardness of the lining layer.

In one embodiment, the flexible portion is a strip structure or a belt structure, and a cross-section of the flexible portion in a width direction is a semicircular structure or a semi-elliptical structure.

In one embodiment, a first opening in communication with the accommodation cavity is provided at an end of the housing portion away from the earhook portion, and the flexible portion covers the first opening and is connected to the housing portion.

In one embodiment, an opening size of the first opening allows the speaker to be inserted and installed into the accommodation cavity.

In one embodiment, the earphone further includes an adapter portion. The adapter portion is located between the housing portion and the earhook portion, and the housing portion is connected to the earhook portion through the adapter portion.

An earphone of the above embodiments. The earphone includes a flexible portion, a housing portion, an earhook portion, and a speaker. In a wearing state, the housing portion includes an inner face facing a user, an outer face away from the user, and a side face connecting the inner face and the outer face. The flexible portion is located on the side face. A small portion of the flexible portion abuts against the cavum conchae wall in the wearing state of the earphone. The flexible portion is a soft structure with elasticity, which deforms relative to the cavum conchae wall under a wearing pressure, increases an area abutting against the cavum conchae wall, reduces a pressure of the earphone squeezing the cavum conchae wall, thereby improving the wearing comfort. Furthermore, the elastic deformation of the flexible portion also adapts to the cavum conchae of different shapes and sizes for different populations.

The flexible portion does not cover the inner wall and the outer wall of the housing portion, to avoid interference by the flexible portion with through holes on the inner wall and the outer wall, reserve a greater area for the inner wall and the outer wall to set the through holes for sound output or pressure relief. Moreover, the flexible portion is disposed at a position between the inner wall and the outer wall. The flexible portion does not increase a thickness of the earphone, so that the earphone has a smaller and more aesthetically pleasing form.

The flexible portion has a preset length, so that the flexible portion does not block a gap between an upper side of the earphone and the external ear canal in the wearing state of the earphone, and does not block a gap between a lower side of the earphone and the external ear canal in the wearing state of the earphone, so that the flexible portion has the wearing comfort and does not affect sound effects of an open earphone.

### BRIEF DESCRIPTION OF THE DRAWINGS

FIG. 1 is a schematic diagram illustrating a structure of a human ear according to an embodiment;

FIG. 2 is a schematic diagram illustrating a structure of an earphone in a wearing state according to an embodiment;

FIG. 3 is a schematic diagram illustrating a structure of an outer side of an earphone according to an embodiment;

FIG. 4 is a schematic diagram illustrating a structure of an inner side of an earphone according to an embodiment;

FIG. 5 is a schematic diagram illustrating structures of a housing portion and a speaker of an earphone separated along a long axis direction according to an embodiment;

FIG. 6 is a schematic diagram illustrating a section of a housing portion of an earphone along a vertical plane of a long axis direction according to an embodiment;

FIG. 7 is a schematic diagram illustrating a structure of an end cover portion of an earphone according to an embodiment;

FIG. 8 is a schematic diagram illustrating a structure of an end cover portion of an earphone according to an embodiment.

FIG. 9 is a schematic diagram illustrating a section of a housing portion of an earphone along a vertical plane of a long axis direction according to an embodiment;

FIG. 10 is a schematic diagram illustrating a section of a connection between a housing portion and an adapter portion of an earphone along a vertical plane of a long axis direction according to an embodiment;

FIG. 11 is a schematic diagram illustrating structures of a housing portion and an adapter portion of an earphone separated along a long axis direction according to an embodiment;

FIG. 12 is a schematic diagram illustrating a structure of an adapter portion of an earphone according to an embodiment;

FIG. 13 is a schematic diagram illustrating an exposed structure of an adapter outer shell and an adapter inner shell of an earphone according to an embodiment;

FIG. 14 is a schematic diagram illustrating a section of a connection between a housing portion and an adapter portion of an earphone along a vertical plane of a long axis direction according to an embodiment; and

FIG. 15 is a schematic diagram illustrating a structure of a separator of an earphone according to an embodiment.

The drawing labels in the drawings are as follows: 101—external ear canal, 102—cavum conchae, 103—cymba conchae, 104—triangular fossa, 105—antihelix, 106—scaphoid fossa, 107—helix, 108—earlobe, 109—crus of helix, P1—first region, P2—second region, P3—third region, A—first gap space, B—second gap space; 10—end cover portion, 11—first flexible section, 12—second flexible section, 121—mounting cavity, 122—sound pickup hole, 13—first sound pickup device, 10a—contact layer, 10b—lining layer; 20—housing portion, 20a—accommodation cavity, 20b—first opening, 20c—second opening, 21—inner wall, 211—first through hole, 22—outer wall, 221—second through hole, 23—upper wall, 24—lower wall, 25—first limiting portion, 26—third limiting portion, 27—protrusion, 28—first guiding portion; 30—adapter portion, 30a—first adapter cavity, 30b—second adapter cavity, 31—adapter inner shell, 311—insertion portion, 3111—fourth limiting portion, 3112—first glue accommodation groove, 32—adapter outer shell, 321—recess, 33—separator, 331—mounting hole, 332—second glue accommodation groove, 333—sealing member, 334—mounting portion; 40—earhook portion; 50—speaker, 51—speaker support, 511—second limiting portion, 512—second guiding portion, 52—flexible circuit board, 521—second electrical connection terminal; 60—circuit board assembly, 61—circuit board, 62—first electrical connection terminal.

### DETAILED DESCRIPTION

The present disclosure is further described in detail below with reference to the accompanying drawings and specific embodiments. Similar elements in different embodiments are denoted by similar associated element reference numerals. In the following embodiments, many details are described to facilitate a better understanding of the present disclosure. However, those skilled in the art may readily recognize that some of the features may be omitted under different circumstances, or may be replaced by other elements, materials, or methods. In some situations, some operations related to the present disclosure are not shown or described in the present disclosure to avoid obscuring a core portion of the present disclosure with excessive description. For those skilled in the art, a detailed description of these related operations is not necessary. Those skilled in the art may fully understand the related operations based on the description in the present disclosure and general technical knowledges in the art.

In addition, features, operations, or characteristics described in the present disclosure may be combined in any suitable manner to form various embodiments. At the same time, steps or actions in the method description may also be sequentially exchanged or adjusted in a manner obvious to those skilled in the art. Therefore, the various sequences in the present disclosure and the accompanying drawings are only for clearly describing a certain embodiment, and do not mean that the sequences are mandatory, unless it is otherwise specified that a certain sequence must be followed.

The serial numbers assigned to components in the present disclosure, such as “first” and “second,” are only used to distinguish the described objects, and have no sequential or technical meaning. The terms “connection” and “coupling” in the present disclosure, unless otherwise specified, include direct and indirect connection (coupling).

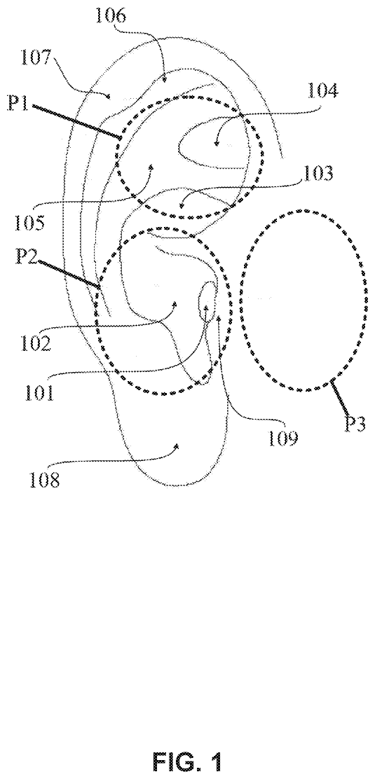

FIG. 1 is a schematic diagram illustrating an exemplary physiological structure of an ear according to some embodiments of an earphone provided in the present disclosure. With reference to FIG. 1, the exemplary ear includes physiological portions such as an external ear canal 101, a cavum conchae 102, a cymba conchae 103, a triangular fossa 104, an antihelix 105, a scapha 106, a helix 107, an earlobe 108, and a crus of helix 109. The external ear canal 101 has a certain depth and extends to a tympanic membrane of the ear. However, unless otherwise specified, the external ear canal 101 may be understood as an entrance (i.e., an ear hole) of the external ear canal 101 away from the tympanic membrane. The physiological portions such as the cavum conchae 102, the cymba conchae 103, and the triangular fossa 104 have a certain volume and depth in a three-dimensional space. The cavum conchae 102 is directly connected to the external ear canal 101. The ear hole may be simply regarded as being located at the bottom of the cavum conchae 102.

For the earphone provided in some embodiments of the present disclosure, a stable wearing of the earphone may be achieved by using one or more physiological portions of the ear.

Merely by way of example, the physiological portions such as the external ear canal 101, the cavum conchae 102, the cymba conchae 103, and the triangular fossa 104 have a certain depth and volume in the three-dimensional space, which satisfies a requirement for a stable wearing of the earphone. When the earphone is in a wearing state, an entirety or a portion of a structure of the earphone may contact an upper portion of the external ear canal 101 (e.g., one or more physiological portions such as the cavum conchae 102, the cymba conchae 103, the triangular fossa 104, the antihelix 105, the scapha 106, the helix 107, and the crus of helix 109). When the earphone is in the wearing state, an entirety or a portion of the structure of the earphone may also be located within one or more physiological portions of the ear. For example, the entirety or a portion of the structure of the earphone is located within a first region P1 at least including the cymba conchae 103 and the triangular fossa 104 enclosed by the dashed line in FIG. 1. As another example, the entirety or a portion of the structure of the earphone may be located within a second region P2 at least including the cavum conchae 102 enclosed by the dashed line in FIG. 1.

Merely by way of example, when the earphone is in the wearing state, the entirety or a portion of the structure of the earphone may also be located on a front side of the crus of helix 109, for example, within a third region P3 enclosed by the dashed line in FIG. 1.

Different users may have individual differences, resulting in dimensional differences such as different shapes and sizes of the ears. For ease of description and understanding and to reduce or even eliminate the individual differences among different users, unless otherwise specified, the present disclosure mainly uses an ear model with a “standard” shape and size as a reference to describe the structures of the earphone in different embodiments and a wearing manner of the earphone on the ear model. Merely by way of example, a simulator (e.g., a GRAS 45BC KEMAR) including a head and ears (left and right) may be manufactured based on ANSI:S3.36, S3.25, and IEC: 60318-7 standards as a reference object for wearing the earphone, thereby presenting a scenario in which most users normally wear the earphone.

Therefore, descriptions such as “worn by a user,” “in a wearing state,” and “under a wearing state” in the present disclosure may refer to the earphone described in the present disclosure being worn on an ear of the simulator. Certainly, considering the individual differences among different users, a structure, a shape, a size, a thickness, etc. of one or more portions of the ear may be designed differently according to the ears of different shapes and sizes. These differentiated designs may be manifested as feature parameters of one or more portions of the earphone with numerical values in different ranges to adapt to different ears.

It should be noted that in fields such as medicine and anatomy, three basic planes of a human body may be defined: a sagittal plane, a coronal plane, and a horizontal plane. Three basic axes of the human body may also be defined: a sagittal axis, a coronal axis, and a vertical axis.

The sagittal plane refers to a plane perpendicular to the ground made along an antero-posterior direction of the body. The sagittal plane divides the human body into a left portion and a right portion. The coronal plane refers to a plane perpendicular to the ground made along a left-right direction of the body. The coronal plane divides the human body into a front portion and a rear portion. The horizontal plane refers to a plane parallel to the ground made along an up-down direction of the body. The horizontal plane divides the human body into an upper portion and a lower portion. Correspondingly, the sagittal axis refers to an axis along the antero-posterior direction of the body and perpendicular to the coronal plane. The coronal axis refers to an axis along the left-right direction of the body and perpendicular to the sagittal plane. The vertical axis refers to an axis along the up-down direction of the body and perpendicular to the horizontal plane.

Further, a term “front side of an ear” in the present disclosure is a concept relative to “rear side of the ear.” The front side of the ear refers to a side of the ear facing a positive axial direction of the external ear canal 101. The rear side of the ear refers to a side of the ear facing away from the positive axial direction of the external ear canal 101. Both the front side of the ear and the rear side of the ear are directed to the ear of the user. A front side outline diagram of the ear shown in FIG. 1 may be obtained by observing the ear of the simulator along a direction of the coronal axis of the human body. It should be noted that the above description of the ear is for illustrative purposes only and is not intended to limit the scope of the present disclosure.

For those skilled in the art, various changes and modifications may be made according to the description of the present disclosure. These changes and modifications still fall within the protection scope of the present disclosure.

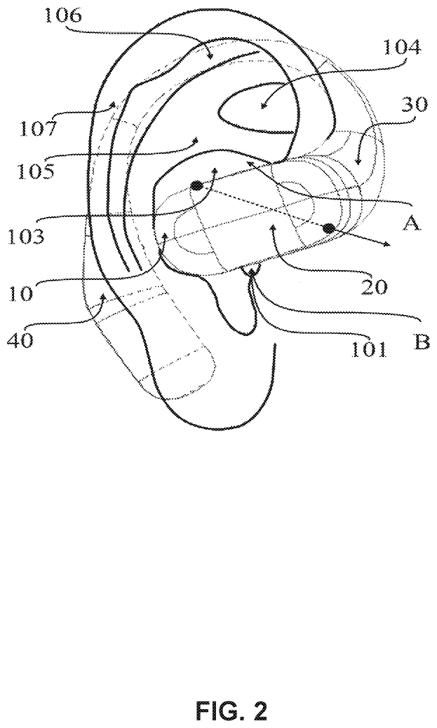

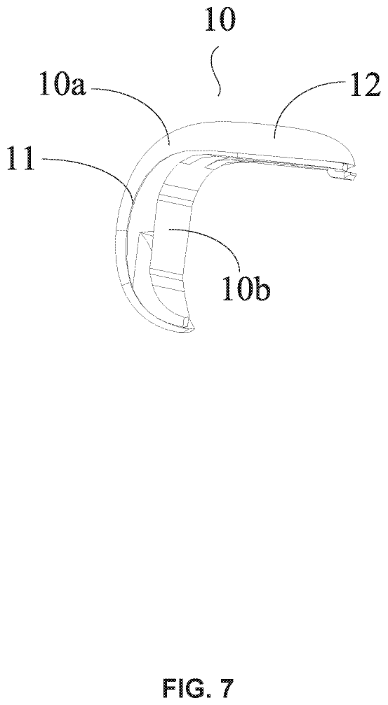

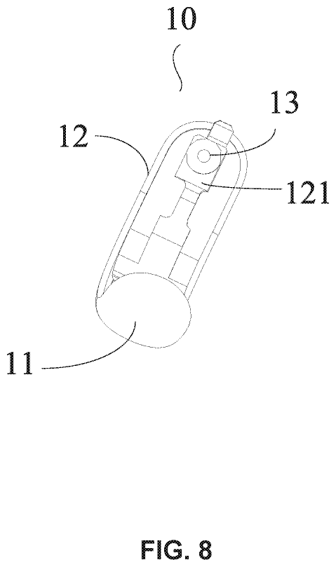

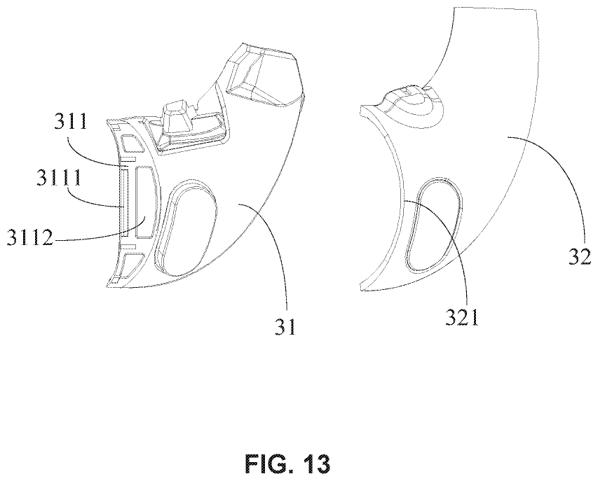

With reference to FIGS. 2-15, the earphone provided in some embodiments of the present disclosure mainly includes an end cover portion 10, a housing portion 20, an adapter portion 30, an earhook portion 40, a speaker 50, and a circuit board assembly 60. The earphone may further include a battery assembly, a microphone assembly, and other functional components that exist as required (e.g., an antenna structure, a key structure, a wearing detection structure, etc.). The following provides a specific description.

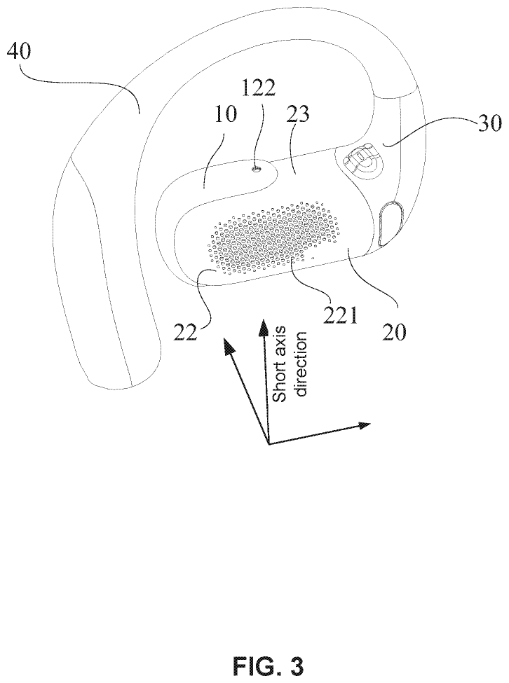

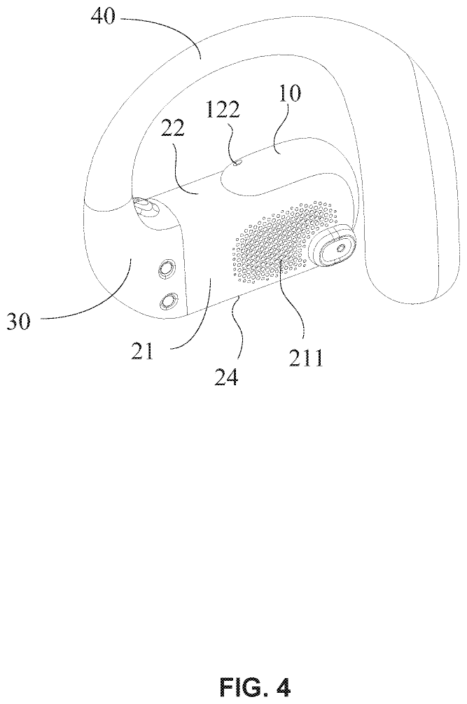

With reference to FIG. 3 and FIG. 4, the adapter portion 30 is connected between the housing portion 20 and the earhook portion 40. The housing portion 20, the adapter portion 30, and the earhook portion 40 together substantially constitute an overall contour shape of the earphone. The end cover portion 10 is connected to an end of the housing portion 20 away from the adapter portion 30. The housing portion 20 may provide a structural assembly space for components such as the speaker 50 and the microphone assembly. One or more of the adapter portion 30 and the earhook portion 40 may provide the structural assembly space for functional components such as the circuit board assembly 60, the battery assembly, and the microphone assembly, etc.

The adapter portion 30 may be understood as a transition structure connecting the housing portion 20 and the earhook portion 40. Merely by way of example, the adapter portion 30 may be a portion of the housing portion 20, for example, a portion of the housing portion 20 used to connect to the earhook portion 40 and occupying a certain structural space may be regarded as the adapter portion 30. Merely by way of example, the adapter portion 30 may be a portion of the earhook portion 40, for example, a portion of the earhook portion 40 used to connect to the housing portion 20 and occupying a certain structural space may be regarded as the adapter portion 30. Merely by way of example, the housing portion 20, the adapter portion 30, and the earhook portion 40 are structures relatively independent of each other. By connecting the adapter portion 30 between the housing portion 20 and the earhook portion 40, an overall approximate contour of the earphone may be assembled.

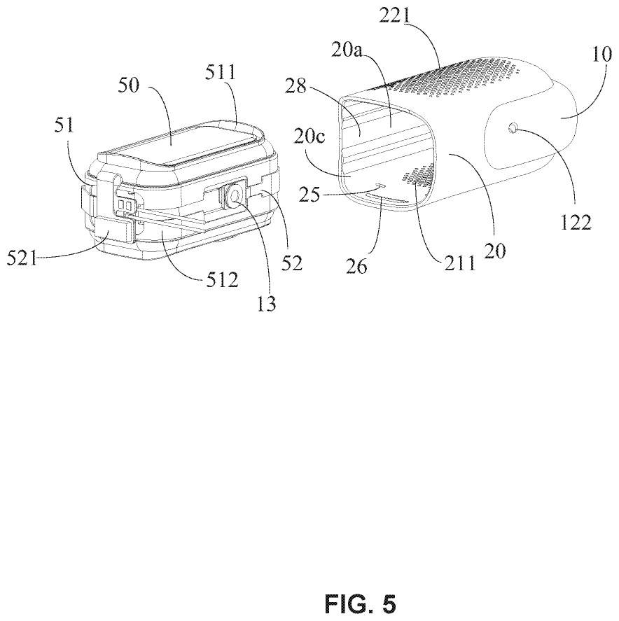

With reference to FIG. 5, the speaker 50 may convert an electrical signal into a sound signal. The speaker 50 may be used to output a noise reduction sound, a user voice, an audio played according to user requirements (e.g., music, reminder sounds), etc. The circuit board assembly 60 may be understood as a main control board or a collection of a main board and related components of the earphone. The circuit board assembly 60 plays a regulatory and management role for all or a portion of the functional components in the earphone. For example, the circuit board assembly 60 is used in the earphone to convert and process the electrical signal to support implementation of various functions of the earphone (e.g., support the earphone to implement functions such as power on/off, playback content switching, volume increase/decrease, etc.).

In some embodiments, with reference to FIG. 2, in the wearing state, the housing portion 20 is located on the front side of the ear. At least a portion of the earhook portion 40 is located between the rear side of the ear and the head. This arrangement allows the earphone to be hung on the ear in the wearing state. For example, the housing portion 20 is set to be located near the external ear canal 101 without blocking the external ear canal 101 in the wearing state, so that the earphone serves as an open earphone. It should be noted that due to individual differences among different users, the housing portion 20 may partially block the external ear canal 101 when the earphone is worn by different users in the wearing state. However, the external ear canal 101 remains unblocked.

To improve a stability of the earphone in the wearing state, the earphone may adopt any one or a combination of several of the following manners.

First, at least a portion of the earhook portion 40 is set as a conformal structure (e.g., an arc-shaped hook) that fits at least one of the rear side of the ear or the head to increase a contact area between the earhook portion 40 and the ear or the head, thereby increasing a resistance of the earphone against falling off from the ear.

Second, at least a portion of the earhook portion 40 is set as an elastic structure to make the earhook portion 40 have a certain amount of elastic deformation in the wearing state, thereby increasing a pressure of the earhook portion 40 on the ear or the head and increasing the resistance to the earphone against falling off from the ear.

Third, at least a portion of the earhook portion 40 is set to abut against the head in the wearing state to make the earhook portion 40 form a reaction force pressing against the ear, so that the housing portion 20 presses against the front side of the ear, thereby increasing the resistance to the earphone against falling off from the ear.

Fourth, the housing portion 20 and the earhook portion 40 are set to clamp physiological portions such as an area where the helix 107 is located and an area where the cavum conchae 102 is located from front and rear sides of the ear respectively in the wearing state, thereby increasing the resistance to the earphone against falling off from the ear.

Fifth, the housing portion 20 or other auxiliary structures (e.g., the adapter portion 30) connected to the housing portion 20 are set to at least partially extend into the physiological portions such as the cavum conchae 102, the cymba conchae 103, the triangular fossa 104, and the scapha 106 in the wearing state, thereby increasing the resistance to the earphone against falling off from the ear.

With reference to FIGS. 2-6, in some embodiments, the end cover portion 10, the housing portion 20, and the adapter portion 30 are sequentially connected to form a three-segment structure. The adapter portion 30 and the earhook portion 40 may also be an integrated structure. In this case, the end cover portion 10, the housing portion 20, and an end of the earhook portion 40 are sequentially connected to form the three-segment structure.

The housing portion 20 has a long axis direction, a short axis direction, and a thickness direction that are perpendicular to each other. The thickness direction is parallel to a vibration direction of the speaker 50 in the housing portion 20. In the wearing state of the earphone, the vibration direction of the speaker 50 is parallel to the coronal axis, the vibration direction of the speaker 50 faces the human body, the vibration direction of the speaker 50 faces an inner wall 21 of a side of the housing portion 20 close to the human body, so that sound emitted by the speaker 50 propagates toward the human ear. In the wearing state of the earphone, the long axis direction of the housing portion 20 is substantially the same as a sagittal axis direction of the human body. The long axis direction may be slightly inclined relative to the antero-posterior direction of the human body. The short axis direction of the housing portion 20 is substantially the same as a direction of the vertical axis of the human body. A thickness direction of the housing portion 20 is substantially the same as a direction of the coronal axis of the human body. With reference to FIG. 2, the long axis direction is inclined relative to the sagittal axis of the human body. The long axis direction is closer to the direction of the sagittal axis of the human body than the short axis direction. The short axis direction is inclined relative to the vertical axis of the human body. The short axis direction is closer to the direction of the vertical axis of the human body than the long axis direction.

The end cover portion 10, the housing portion 20, and the adapter portion 30 are sequentially connected and distributed along the long axis direction of the housing portion 20 to form the three-segment structure along the long axis direction. An arrangement direction (the long axis direction) of the three-segment structure is not parallel to the vibration direction of the speaker 50. For example, the long axis direction and the vibration direction form a relatively large crossing angle. As another example, the long axis direction and the vibration direction are perpendicular to each other. In this way, connection points of the three-segment structure may be staggered from the vibration direction of the speaker 50 as much as possible to avoid a potential impact on a sound output effect of the speaker 50 caused by a gap that exists at the connection points of the three-segment structure after a long-term use.

The housing portion 20 may be a tubular structure. An accommodation cavity 20a is formed in the tubular structure of the housing portion 20. The housing portion 20 has a first opening 20b at an end in the long axis direction. The housing portion 20 has a second opening 20c at the other end in the long axis direction. The first opening 20b and the second opening 20c are located at two ends of the accommodation cavity 20a and communicate with the accommodation cavity 20a.

The tubular structure of the housing portion 20 may be a rectangular tubular structure, a cylindrical tubular structure, an elliptical cylindrical tubular structure, a rhombic tubular structure, etc. It is understandable that any cavity structure with openings at both ends may serve as a specific structure of the housing portion 20, which falls within the protection scope of the present disclosure.

In the three-segment structure, the housing portion 20 has the first opening 20b and the second opening 20c on two sides. The end cover portion 10 covers the first opening 20b. The adapter portion 30 covers the second opening 20c. The end cover portion 10, the housing portion 20, and the adapter portion 30 may be quickly assembled along the long axis direction. The housing portion 20 forms the tubular structure with openings at both ends. The tubular structure of the housing portion facilitates installation of components in the housing portion 20. The three-segment structure of the earphone may reduce an installation difficulty of the end cover portion 10, the housing portion 20, the adapter portion 30, and the speaker 50, thereby improving an assembly efficiency of the earphone.

The end cover portion 10 covers the first opening 20b and connects the housing portion 20. At least a portion of the end cover portion 10 abuts against a cavum conchae wall in the wearing state. An entirety or an outer layer of the end cover portion 10 may be made of a flexible material to improve a comfort for the user in the wearing state. The adapter portion 30 covers the second opening 20c and connects the housing portion 20. In a finished product, the end cover portion 10 and the adapter portion 30 cover the first opening 20b and the second opening 20c, respectively. In some embodiments, the connections in the three-segment structure are relatively tight. There is no gap at the connection positions, or the gaps at the connection positions are sealed by a waterproof structure to ensure sealing in the housing portion 20 and avoid a water ingress.

In some embodiments, the first opening 20b and the second opening 20c have sufficient opening sizes. An opening area of at least one of the first opening 20b or the second opening 20c is greater than a maximum sectional area of the speaker 50 in a cross section taken parallel to the vibration direction of the speaker 50. Therefore, during the assembly of the earphone 100, the speaker 50 may be first inserted into the accommodation cavity 20a of the housing portion 20 through the first opening 20b or the second opening 20c. Then, the end cover portion 10 and the adapter portion 30 are installed on the first opening 20b and the second opening 20c, respectively. In this embodiment, the installation of the speaker 50 is facilitated by installing the speaker 50 into the housing portion 20 through the first opening 20b or the second opening 20c.

In some embodiments, the speaker 50 is installed into the accommodation cavity 20a of the housing portion 20 by insertion. The speaker 50 may be fixedly installed immediately after insertion. For example, a limiting portion is provided in the housing portion 20, and a limiting portion is provided at an outer shell of the speaker 50. The two limiting portions are complementary and adapted structures such as a clip and a slot, etc. After the speaker 50 is inserted into the accommodation cavity 20a of the housing portion 20, the two corresponding limiting portions engage with each other to achieve a fixed limitation of the speaker 50. That is, the speaker 50 may be installed and fixed by a one-step insertion manner. The one-step insertion manner may simplify installation steps and improve an installation efficiency. Furthermore, an installation accuracy of the speaker 50 may be ensured, such that the vibration direction of the speaker 50 is parallel to the thickness direction of the housing portion 20.

In some embodiments, the opening sizes of both the first opening 20b and the second opening 20c satisfy the insertion installation of the speaker 50 into the housing portion 20, thereby providing a higher installation freedom for the installation of the speaker 50. If a structure or a positioning structure of the speaker 50 is different, the speaker 50 may be inserted and installed into the housing portion 20 through one of the first opening 20b and the second opening 20c according to a specific structure. Furthermore, both the first opening 20b and the second opening 20c may allow the insertion installation of the speaker 50, which is also beneficial for the disassembly of the speaker 50 during maintenance. For example, the speaker 50 is inserted from one opening and pulled out from the other opening. The insertion and the pulling out allow a flexible circuit board etc. to be installed and disassembled in one direction, thereby avoiding damage from bending back of the flexible circuit board.

It is understandable that, in some other embodiments of the present disclosure, the housing portion 20 is also formed by combining two housings. When the speaker 50 is installed in the accommodation cavity 20a of the housing portion 20, the speaker 50 is first installed on one of the housings, then the other housing is fixed to the housing with the speaker 50 installed, forming the housing portion 20 with openings at both ends. Subsequently, the end cover portion 10 and the adapter portion 30 are installed, respectively.

Referring to FIG. 3, in this embodiment, the housing portion 20 is an integrated tubular structure. The long axis direction of the housing portion 20 is perpendicular to the vibration direction of the speaker 50, “perpendicular” here includes an absolute “perpendicular” and an approximately “perpendicular.” The first opening 20b and the second opening 20c are located at two end positions of the housing portion 20 in the long axis direction. The housing portion 20 may form a straight tubular structure to simplify the structure of the housing portion 20. The straight tubular structure also allows the first opening 20b and the second opening 20c to directly communicate with the accommodation cavity 20a of the housing portion 20. The first opening 20b, the accommodation cavity 20a, and the second opening 20c are distributed on a straight line. Therefore, the speaker 50 may be linearly inserted and installed into the accommodation cavity 20a along the long axis direction. The installation manner for this structure is simpler and more efficient. Furthermore, opening directions of the first opening 20b and the second opening 20c are completely misaligned with the vibration direction of the speaker 50. Connection structures at the first opening 20b and the second opening 20c do not affect a sound output of the speaker 50. For example, the connection structures do not block the sound output, or gaps in the connection structures, if present, do not interfere with the sound output.

In this embodiment, the end cover portion 10, the housing portion 20, and the adapter portion 30 are connected in sequence to form the three-segment structure. In the three-segment structure, the speaker 50 is directly inserted and installed into the housing portion 20 through the openings on two sides of the housing portion 20. The installation manner achieves a one-step insertion installation of the speaker 50, without first fixing the speaker 50 on one housing of the housing portion 20 and then assembling. That is, the three-segment structure of the earphone simplifies the installation steps of the speaker and improves the assembly efficiency.

The three-segment structure of the earphone is also beneficial for the installation stability of the speaker 50. An outer wall of a large-sized speaker 50 may directly abut against an inner wall of the housing portion 20. The tubular structure of the housing portion 20 may form a restraining, wrapping, limiting, and fixing effect on the speaker 50, thereby improving the installation stability of the speaker.

The three-segment structure of the earphone simplifies the structure of the housing portion 20. The openings at the two ends of the housing portion 20 may connect installation ports, or may also serve as wire routing ports for the flexible circuit board or a cable to pass through. The openings at the two ends of the housing portion 20 facilitate the electrical connections between the speaker 50 and other components. The openings also simplify the structure of the housing portion 20. The housing portion 20 does not need to be provided with separate installation ports and wire routing ports.

The three-segment structure of the earphone may also form a more aesthetically pleasing appearance. The housing portion 20 may be manufactured as an integrated structure. An outer side face of the tubular structure of the housing portion 20 may be a smooth and seamless face, which is more aesthetically pleasing, especially when the outer surface of the housing portion 20 is coated, a complete pattern may be formed.

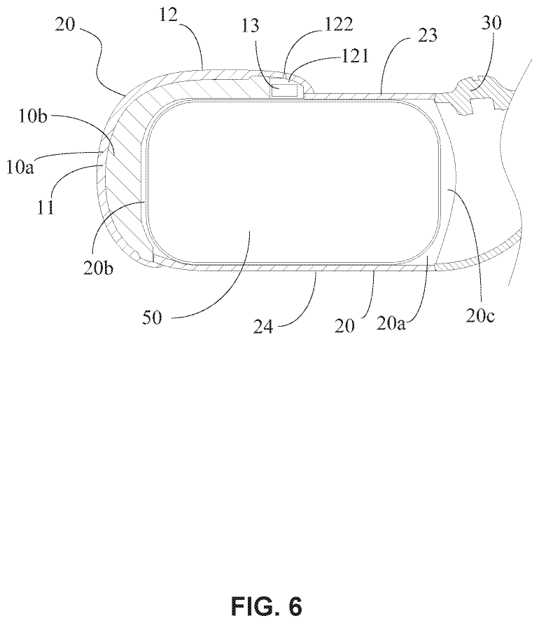

Referring to FIG. 6, in some embodiments, one of the first opening 20b and the second opening 20c has a sufficient opening size. That is, the opening area of one of the first opening 20b and the second opening 20c is greater than the maximum sectional area of the speaker 50 in a cross section taken parallel to the vibration direction of the speaker 50. The opening area of the other one is less than the maximum sectional area of the speaker 50 in a cross section taken parallel to the vibration direction of the speaker 50. For example, the first opening 20b has a relatively small opening and does not allow the speaker 50 to pass through the first opening 20b for insertion installation into the housing portion 20. The second opening 20c has a relatively great opening and allows the speaker 50 to pass through the second opening 20c for insertion installation into the housing portion 20. Alternatively, the first opening 20b has a relatively great opening and allows the speaker 50 to pass through the first opening 20b for insertion installation into the housing portion 20. The second opening 20c has a relatively small opening and does not allow the speaker 50 to pass through the second opening 20c for insertion installation into the housing portion 20. In this structure, one opening at one end of the housing portion 20 may allow the insertion installation of the speaker 50 into the housing portion 20 and also achieve the one-step insertion installation of the speaker 50. The structure has advantages such as a high installation efficiency, a more accurate positioning, a more stable structure, etc.

In some embodiments, the long axis direction of the housing portion 20 is not parallel to the vibration direction of the speaker 50. For example, the long axis direction of the housing portion 20 and the vibration direction of the speaker 50 are arranged crosswise. An angle between the long axis direction of the housing portion 20 and the vibration direction of the speaker 50 is 45° or 60°. In this structure, the speaker 50 may be installed into the accommodation cavity 20a of the housing portion 20 along an inclined direction to achieve a rapid insertion installation of the speaker 50. The first opening 20b and the second opening 20c are also misaligned with the vibration direction of the speaker 50. The connection structures at the first opening 20b and the second opening 20c also do not affect the sound output of the speaker 50.

Referring to FIG. 3 and FIG. 4, in some embodiments, specifically, in the wearing state, the housing portion 20 includes an inner wall 21 facing an ear along the vibration direction of the speaker 50, an outer wall 22 facing away from the ear, an upper wall 23 facing upward, and a lower wall 24 facing downward. The inner wall 21 and the outer wall 22 are located on two sides of the housing portion 20 in a thickness direction (the vibration direction of the speaker 50). The upper wall 23 and the lower wall 24 are located on two sides of the housing portion 20 in the short axis direction. The first opening 20b and the second opening 20c are located on two sides of the housing portion 20 in the long axis direction. The outer wall 22, the upper wall 23, the inner wall 21, and the lower wall 24 are connected in sequence to enclose to form the accommodation cavity 20a. The outer wall 22, the upper wall 23, the inner wall 21, and the lower wall 24 may each be a planar structure or a curved surface structure. Arc-shaped fillets may be provided at positions where the outer wall 22, the upper wall 23, the inner wall 21, and the lower wall 24 are connected to each other. The arc-shaped fillets make an outer contour of the housing portion 20 smoother. The smoother outer contour may improve the wearing comfort and aesthetic degree.

In the wearing state, the earphone has an inner face facing a user, an outer face facing away from the user, and a side face connecting the inner face and the outer face. A flexible portion is located on the side face. In some embodiments of the present disclosure, the inner face of the earphone is an outer surface of the inner wall 21 of the housing portion 20. The outer face of the earphone is an outer surface of the outer wall 22 of the housing portion 20. A side face of the earphone is a face of the earphone located between the outer surface of the inner wall 21 and the outer surface of the outer wall 22.

The housing portion 20 may be made of a hard structural material such as metal or plastic. The housing portion 20 made of the hard structural material may form a stable accommodation cavity 20a to achieve a stable installation of components such as the speaker 50. In some embodiments, the housing portion 20 is made of a metal material to form a glossy outer surface to enhance a texture and the aesthetic degree of the earphone.

The housing portion 20 may be a single-layer structure. The housing portion 20 may be set with a relatively small thickness. A reinforcing structure is provided in the housing portion 20 to minimize a weight of the earphone while ensuring a strength of the housing portion 20 of the earphone. In some embodiments, the reinforcing structure also forms a snap-fit portion to position and fix the speaker 50. The housing portion 20 also adopts a multi-layer composite structure. For example, the housing portion 20 includes a lining and an outer layer. The lining is a support layer with a relatively high structural strength. The outer layer is a metal layer or a silicone layer with a good tactile feel and a comfortable wearing contact.

The housing portion 20 may be an integrated structure. The housing portion 20 is integrally formed from a single material or a mixed material. The integrally formed housing portion 20 has a higher structural stability. The integrally formed housing portion 20 also forms a seamless appearance surface. It is understandable that, in some other embodiments of the present disclosure, the housing portion 20 is also spliced together by multiple housings through manners such as snap-fitting, welding, or bonding.

Referring to FIG. 3 and FIG. 4, in some embodiments, the inner wall 21 of the housing portion 20 is provided with a first through hole 211 penetrating through the inner wall 21. The first through hole 211 forms an acoustic connection (allowing a mutual propagation of sound) with a sound generation face of the speaker 50. The sound generation face of the speaker 50 faces the first through hole 211. The first through hole 211 is a sound outlet hole. Sound emitted by the speaker 50 may pass through the first through hole 211 and enter the human ear. The outer wall 22 of the housing portion 20 is provided with a second through hole 221 penetrating through the outer wall 22. The sound generation face of the speaker 50 faces away from the second through hole 221. The second through hole 221 is a pressure relief hole. The second through hole 221 provides a venting and pressure relief function for the speaker 50 in the housing portion 20. The venting and pressure relief function improves an audio playback effect quality of the speaker 50 and achieves a higher active noise reduction effect.

The first through hole 211 and the second through hole 221 may be micro-hole array structures. It is understandable that the micro-hole array structure is an array structure with tiny holes. The holes may be formed by directly punching holes in a side wall of the housing portion 20. The holes may also refer to small holes on an acoustic steel mesh or an acoustic gauze (i.e., the inner wall 21 or the outer wall 22 may be made of the acoustic steel mesh or the acoustic gauze).

On one hand, using the form of the micro-hole array structure for the first through hole 211 and the second through hole 221 may ensure a rigidity of the housing portion 20 while ensuring an effective area for sound output. Therefore, the earphone may have sufficient strength while ensuring a high-intensity sound output, thereby providing support for ensuring a listening effect and enhancing the active noise reduction effect.

On the other hand, the first through hole 211 and the second through hole 221 are arranged as a micro-hole array structure, and the two sides of the speaker 50 in the vibration direction are acoustically connected to the first through hole 211 and the second through hole 221, respectively, which balances an internal air pressure when the speaker 50 vibrates while ensuring the sound output efficiency, avoids problems such as affecting an overall appearance of the earphone, accumulating dirt and impurities, and requiring additional pressure relief holes, which are prone to occur when a single through hole with a great aperture is used, and also avoids problems such as a high acoustic resistance, a low sound output efficiency, and a poor listening effect, which are prone to occur when a single through hole with a small aperture is used.

In other embodiments, the first through hole 211 and the second through hole 221 also adopt a single-hole structure with the large aperture or a multi-hole structure, and the first through hole 211 and the second through hole 221 are covered by using an acoustic steel mesh, an acoustic gauze, etc., which also achieves the technical effect of waterproofing and dustproofing while ensuring the effective area for sound output.

In some embodiments, the housing portion 20 is provided with the first through hole 211 penetrating the inner wall 21 only on the inner wall 21. The sound generation face of the speaker 50 faces the first through hole 211. The outer wall 22 of the housing portion 20 is not provided with the second through hole 221. This structure also satisfies usage requirements of some scenarios with lower sound quality requirements or some users with lower sound quality requirements.

Referring to FIG. 5, in some embodiments, the earphone may further include a speaker support 51. The speaker support 51 may be a frame-type structure. The speaker support 51 may be formed by combining a plurality of plates or sheet structures. For example, the speaker support 51 is a ring structure. The speaker 50 is mounted in the speaker support 51. The speaker support 51 surrounds the speaker 50. The speaker support 51 surrounds the side faces of the speaker 50 in the long axis direction and the short axis direction. The speaker support 51 does not cover the side face of the speaker 50 in the vibration direction (the thickness direction) to prevent the speaker support 51 from blocking the vibration and the sound output of the speaker 50. The speaker support 51 may also have other structures, for example, a C-shaped structure. The C-shaped structure may also achieve positioning and mounting of the speaker 50.

On one hand, the speaker support 51 may be used to mount and fix the speaker 50 in the housing portion 20. The speaker support 51 may be snap-fitted and fixed to the housing portion 20, and the speaker 50 may directly adopt a conventional standard component. The speaker support 51 may also be snap-fitted and fixed to the housing portion 20 through elastic deformation, etc. Similarly, the speaker support 51 may also be fixed to the speaker 50 through elastic deformation, etc. During mounting, the speaker 50 is first mounted on the speaker support 51, then the combination of the speaker 50 and the speaker support 51 is inserted into the housing portion 20 together.

On the other hand, the earphone further includes electrical connection components such as a flexible circuit board 52. The speaker support 51 may also be used to limit and fix the electrical connection components such as the flexible circuit board 52 electrically connected to the speaker 50. The electrical connection components such as the flexible circuit board 52 may be fixed to the speaker support 51 by passing through, embedding, snap-fitting, etc. The electrical connection components such as the flexible circuit board 52 may also be clamped and mounted between the speaker support 51 and the speaker 50. After the electrical connection components such as the flexible circuit board 52 are fixedly mounted to the speaker support 51, the combination is inserted into the housing portion 20 together. The electrical connection components such as the flexible circuit board 52 are not disturbed during insertion. This arrangement ensures a stability of the electrical connection between the electrical connection components such as the flexible circuit board 52 and the speaker 50, and facilitates a quick mounting of the speaker 50 and the electrical connection components such as the flexible circuit board 52.

In some embodiments, the earphone may not include the speaker support 51. An outer side face of the speaker 50 includes a snap-fit or a limiting structure corresponding to an interior of the housing portion 20. This arrangement also achieves a positioning and a fixed connection between the speaker 50 and the housing portion 20. Alternatively, the outer side face of the speaker 50 is directly bonded and fixed to an inner wall face of the housing portion 20 through adhesive, etc. The outer side face of the speaker 50 may also include limiting and fixing structures such as a snap-fit hole or a limiting hole to mount and fix the electrical connection components such as the flexible circuit board 52.

Referring to FIG. 5, in some embodiments, the inner side wall of the housing portion 20 (the side wall of the accommodation cavity 20a) includes a first limiting portion 25. The speaker support 51 includes a second limiting portion 511 corresponding to the first limiting portion 25. The first limiting portion 25 and the second limiting portion 511 may be limiting connection structures with complementary and adapted structures. For example, one of the first limiting portion 25 and the second limiting portion 511 is a snap, and the other is a snap slot. The limiting connection between the first limiting portion 25 and the second limiting portion 511 may limit and fix the speaker support 51 in the housing portion 20. This arrangement further limits and fixes the speaker 50 at a preset position in the housing portion 20. The first limiting portion 25 and the second limiting portion 511 may be snap-fitted through elastic deformation. An elastic deformation force between the first limiting portion 25 and the second limiting portion 511 may improve a stability of the connection between the speaker support 51 and the housing portion 20.

Referring to FIG. 5, in some embodiments, the inner side wall of the housing portion 20 (the side wall of the accommodation cavity 20a) is provided with a first guiding portion 28. The speaker support 51 includes a second guiding portion 512 corresponding to the first guiding portion 28. The first guiding portion 28 and the second guiding portion 512 are slidable structures with complementary and adapted structures. For example, one of the first guiding portion 28 and the second guiding portion 512 is a sliding groove, and the other is a protruding sliding block. The sliding block slides relative to the sliding groove. A guiding sliding direction of the first guiding portion 28 and the second guiding portion 512 is parallel to the long axis direction of the housing portion 20. That is, the guiding sliding direction of the first guiding portion 28 and the second guiding portion 512 is parallel to an insertion direction of the speaker support 51. The arrangement of the first guiding portion 28 and the second guiding portion 512 allows the combination of the speaker support 51 and the speaker 50 to be inserted into the housing portion 20 along the guiding direction (the long axis direction). This arrangement improves an accuracy of inserting and mounting the combination of the speaker support 51 and the speaker 50 into the housing portion 20.

The first guiding portion 28 is arranged only on one side face of the inner side wall of the housing portion 20. Alternatively, the inner side wall of the housing portion 20 includes a plurality of asymmetric first guiding portions 28. One or more second guiding portions 512 are arranged at corresponding positions of the speaker support 51. With such an arrangement, the first guiding portion 28 and the second guiding portion 512 may serve as a fool-proofing function to prevent the vibration direction of the speaker 50 from being mounted incorrectly or in reverse.

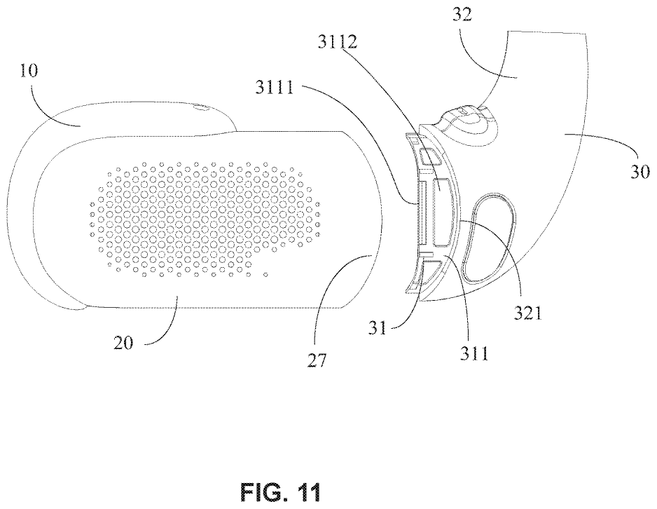

Referring to FIGS. 11-13, in some embodiments, the adapter portion 30 includes an adapter inner shell 31 and an adapter outer shell 32. The adapter inner shell 31 is connected to the housing portion 20. The adapter outer shell 32 is sleeved and covers the outer side of the adapter inner shell 31. The adapter outer shell 32 and the adapter inner shell 31 may be connected by snap-fitting, bonding, welding, interference fit, bonding, etc. The adapter outer shell 32 and the earhook portion 40 (e.g., an earhook outer sleeve) may be connected by bonding, welding, etc. A Shore hardness of the adapter outer shell 32 is less than a Shore hardness of the adapter inner shell 31. For example, the adapter outer shell 32 is made of silicone or rubber material. The adapter inner shell 31 is made of a relatively hard plastic material or other insulating materials.

The adapter inner shell 31 is relatively hard. The adapter inner shell 31 may stabilize a contour shape of the adapter portion 30 to provide a structural support for components such as a key structure and a circuit board assembly 60 mounted in the adapter portion 30. The adapter outer shell 32 is relatively soft. The adapter outer shell 32 may contact human skin in the wearing state, thereby effectively improving the wearing comfort of the earphone. The combination of soft and hard materials also facilitates disassembly, maintenance, and assembly of the adapter portion 30 and related components. The combination of soft and hard materials also enhances the stability of the structural connection among the adapter portion 30, the housing portion 20, and the earhook portion 40.

In some embodiments, referring to FIG. 3 and FIG. 4, the adapter outer shell 32 and the earhook outer sleeve of the earhook portion 40 are an integrated structure. Merely by way of example, the adapter outer shell 32 and the earhook outer sleeve are an integrated structure (e.g., a tubular structure) made of silicone material. The adapter inner shell 31 is a shell structure made of a relatively hard material such as plastic. The adapter inner shell 31 is inserted into the adapter outer shell 32 by interference fit, bonding, etc., to make the adapter portion 30 a structural form with a cavity.

In this way, based on the integrated structure of the adapter outer shell 32 and the earhook outer sleeve, the integrity of the contour structure of the earhook portion 40 and the adapter portion 30 is ensured. The adapter portion 30 may be quickly formed by inserting the adapter inner shell 31 into the adapter outer shell 32. This arrangement provides support for improving a structural stability of the adapter portion 30 and for quickly disassembling and assembling related components.

In some embodiments, the adapter portion 30 is a single-layer structure. The adapter portion 30 and the earhook portion 40 is an integrated structure.

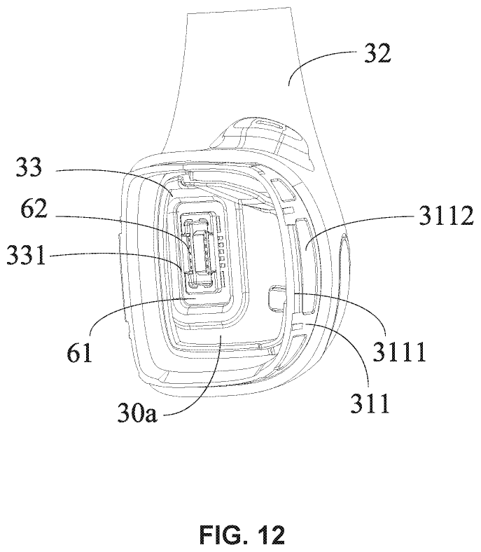

Referring to FIG. 11 and FIG. 12, in some embodiments, an end of the adapter inner shell 31 close to the housing portion 20 protrudes from the adapter outer shell 32 to form an insertion portion 311. That is, the end of the adapter inner shell 31 is not covered and wrapped by the adapter outer shell 32. The insertion portion 311 is inserted into the second opening 20c of the housing portion 20 and fixedly connected to the housing portion 20. The outer surface of the adapter outer shell 32 may be flush with the outer surface of the housing portion 20 to form a smoother and more integrated appearance. This arrangement improves handling feel and aesthetics of the earphone.

A third limiting portion 26 is arranged at a position on the inner side wall of the housing portion 20 close to the second opening 20c. A circumferential outer side face of the insertion portion 311 of the adapter inner shell 31 includes a fourth limiting portion 3111. The third limiting portion 26 and the fourth limiting portion 3111 may be limiting connection structures with complementary and adapted structures. For example, one of the third limiting portion 26 and the fourth limiting portion 3111 is a snap, and the other is a snap slot. The snap formed by the third limiting portion 26 and the fourth limiting portion 3111 may fix the insertion portion 311 in the housing portion 20. This arrangement achieves a fixed connection between the housing portion 20 and the adapter portion 30.

Referring to FIG. 11 and FIG. 12, in some embodiments, a circumferential outer wall of the insertion portion 311 may further include a first adhesive accommodation groove 3112. Before the insertion portion 311 is inserted into the housing portion 20, adhesive may be preset in the first adhesive accommodation groove 3112. After the insertion portion 311 is inserted into the housing portion 20, the adhesive contacts the inner side wall of the housing portion 20. After the adhesive solidifies, the insertion portion 311 and the housing portion 20 are bonded and fixed. This arrangement further improves the stability of the connection between the housing portion 20 and the adapter portion 30. The adhesive may also serve a sealing function. The adhesive seals a gap at the connection between the housing portion 20 and the adapter portion 30 to prevent water from entering from the connection between the housing portion 20 and the adapter portion 30. The arrangement of the first adhesive accommodation groove 3112 may form an accommodation cavity to accommodate more adhesive. More adhesive may improve the stability of bonding between the housing portion 20 and the adapter portion 30 and improve a sealing effect.

In some embodiments, the first adhesive accommodation groove 3112 is also arranged on the inner side wall of the housing portion 20. Alternatively, the first adhesive accommodation groove 3112 is not arranged. The adhesive is coated on the circumferential outer wall of the insertion portion 311 or the inner side wall of the housing portion 20. This arrangement also achieves the bonding between the insertion portion 311 and the housing portion 20.

In some embodiments, a limiting component may not be arranged between the insertion portion 311 and the housing portion 20. The insertion portion 311 and the housing portion 20 are directly and fixedly connected by interference fit, bonding, etc. This arrangement also achieves the fixed connection between the insertion portion 311 and the housing portion 20.

Referring to FIG. 5, FIG. 6, and FIG. 12, in some embodiments, an end face of the housing portion 20 with the second opening 20c is a first inclined face. The first inclined face is inclined relative to a section parallel to the vibration direction of the speaker 50. If the end face of the housing portion 20 with the second opening 20c is not arranged as the inclined face, the end face is perpendicular to the outer surface of the housing portion 20. The first inclined face is inclined relative to the outer surface of the housing portion 20. Correspondingly, an end face of the adapter outer shell 32 close to the housing portion 20 is a second inclined face. The second inclined face is inclined relative to the section parallel to the vibration direction of the speaker 50. Similarly, the second inclined face is inclined relative to the outer surface of the adapter outer shell 32. The first inclined face and the second inclined face have the same inclination angle magnitude and the same inclination direction. When the housing portion 20 and the adapter outer shell 32 are butted, the first inclined face and the second inclined face may be adaptively butted. The inclination angles of the first inclined face and the second inclined face may be set according to requirements. For example, the inclination angles of the first inclined face and the second inclined face are both +45° or both −30°. The arrangement of the first inclined face and the second inclined face increases a contact area for butting between the adapter outer shell 32 and the housing portion 20, improves a stability of butting between the adapter outer shell 32 and the housing portion 20, increases a path length from outside to inside at the connection between the adapter outer shell 32 and the housing portion 20, and improves the sealing with a better water-blocking effect.

In some embodiments, the first inclined face and the second inclined face may also be replaced with faces of other shapes and structures to improve the sealing of butting between the adapter outer shell 32 and the housing portion 20.

For example, the first inclined face and the second inclined face are replaced with complementary wavy faces or zigzag faces, which not only increases a contact area for butting between the adapter outer shell 32 and the housing portion 20 and improves the sealing of butting between the adapter outer shell 32 and the housing portion 20, but also serves to limit an axial rotation to improve the accuracy of butting between the adapter outer shell 32 and the housing portion 20.

As another example, one of the first inclined face and the second inclined face is replaced by a concave surface, and the other is replaced by a convex surface. The concave surface and the convex surface are adaptively arranged. The butting of the concave surface and the convex surface may also increase the contact area for butting between the adapter outer shell 32 and the housing portion 20 and improve the sealing of butting between the adapter outer shell 32 and the housing portion 20.

In some embodiments, the end face of the adapter outer shell 32 close to the housing portion 20 elastically abuts against the end face of the housing portion 20 having the second opening 20c, so that an external liquid is difficult to enter the interior of the housing portion 20 from a connection between the adapter outer shell 32 and the housing portion 20. This arrangement achieves the sealing between the adapter outer shell 32 and the housing portion 20 to protect components such as the speaker 50 in the housing portion 20, and improves the waterproof effect of the earphone 100.

In some embodiments, a portion of the adapter outer shell 32 extends above the first adhesive accommodation groove 3112 of the insertion portion 311 of the adapter inner shell 31. For example, an end portion with the second inclined face extends at least partially above the first adhesive accommodation groove 3112. With such a configuration, during installation, the adhesive covers a lower position of the connection between the adapter outer shell 32 and the housing portion 20. The adhesive may seal the connection between the adapter outer shell 32 and the housing portion 20 to provide a better sealing effect.

In some embodiments, at least a portion of the housing portion 20 extends toward the adapter portion 30 along the long axis direction to form a protrusion 27. The adapter outer shell 32 is provided with a recess 321 complementary to the protrusion 27. The recess 321 of the adapter outer shell 32 may expose a greater area of the adapter inner housing 31, and the insertion portion 311 has an exposed region that the recess 321 avoids and exposes. The exposed region has a greater area. The first adhesive accommodation groove 3112 may be disposed in the exposed region. In this way, an area of a circumferential outer side wall of the insertion portion 311 of the adapter inner housing 31 is increased. A contact area between the housing portion 20 and the adapter inner housing 31 is increased. Such a structure also allows for a first adhesive accommodation groove 3112 with a greater volume to be provided, allowing more adhesive to be injected, which improves stability and the sealing of the plug-in connection between the housing portion 20 and the adapter inner housing 31.

For example, one end of the outer wall 22 of the housing portion 20 is provided with the extending protrusion 27 near an end close to the adapter outer shell 32. A front side wall corresponding to the adapter outer shell 32 is provided with the recess 321. The protrusion 27 and the recess 321 may be arc-shaped edge structures that are protruding and recessed, respectively. Arranging the protrusion 27 on a front side of the housing portion 20 can display an arc-shaped connection line between the housing portion 20 and the adapter outer shell 32, which enhances the aesthetic appeal of the design. At the same time, the protrusion 27 cooperates with the connection line between the other end of the housing portion 20 away from the adapter outer shell 32 and the end cover portion 10 to form a symmetrical arc-shaped connection line, which further enhances the aesthetic appeal.

In some embodiments, a portion or all of an end portion of the adapter outer shell 32 protrudes toward the adapter inner housing 31 and extends into the first adhesive accommodation groove 3112. The adapter outer shell 32 is arranged to protrude inward. The protruding portion limits a position of the adapter outer shell 32 along the long axis direction, and increases a contact area between the end portion of the adapter outer shell 32 and the adhesive, thereby improving the sealing effect.

Referring to FIG. 11, in some embodiments, the ends of the inner wall 21 and the outer wall 22 of the housing portion 20 close to the adapter outer shell 32 are also provided with the protrusions 27. The adapter outer shell 32 is correspondingly provided with recesses on the inner and outer sides. A contact area between the housing portion 20 and the adapter inner housing 31 may be further increased, thereby improving the sealing of a connection between the housing portion 20 and the adapter inner housing 31.

Referring to FIGS. 6-8, in some embodiments, the end cover portion 10 is a flexible portion. The flexible portion is located on the side face of the earphone. At least a portion of the flexible portion is disposed at a position abutting against the cavum conchae wall in the wearing state of the earphone, such that the flexible portion abuts against the cavum conchae wall in the wearing state of the earphone. The flexible portion is a soft structure with elasticity. The flexible portion elastically deforms relative to the cavum conchae wall under the wearing pressure, which increases an area abutting against the cavum conchae wall, and reduces the pressure of the earphone squeezing the cavum conchae wall, thereby improving the wearing comfort. Furthermore, the elastic deformation of the flexible portion also adapts to the cavum conchae of different shapes and sizes for different populations. The elastic deformation allows an increased contact area between the earphone and the cavum conchae wall for different populations in the wearing state, thereby ensuring the wearing comfort. The flexible portion has a preset length. The flexible portion does not block a gap between an upper side of the earphone and the external ear canal in the wearing state of the earphone, and does not block a gap between a lower side of the earphone and the external ear canal in the wearing state of the earphone, so that the flexible portion considers the wearing comfort without affecting an open nature of the earphone.

The flexible portion is located at a position between an outer surface of the inner wall 21 and an outer surface of the outer wall 22. In some embodiments of the present disclosure, the flexible portion is located on the side face of the earphone, and at a position between the outer surface of the inner wall 21 and the outer surface of the outer wall 22. The outer surface of the flexible portion is not coplanar with the outer surface of the inner wall 21 and/or the outer surface of the outer wall 22. Specifically, in some embodiments of the present disclosure, the outer surface of the flexible portion is not coplanar with the outer surface of the inner wall 21 and the outer surface of the outer wall 22. In the thickness direction of the housing portion 20, the flexible portion does not protrude beyond the inner wall 21 or the outer wall 22 of the housing portion 20, thereby ensuring the aesthetics of the earphone 100 and an overall strength of the earphone 100.

The flexible portion does not cover the inner wall 21 and the outer wall 22 of the housing portion 20, thereby avoiding an interference of the flexible portion with through holes on the inner wall 21 and the outer wall 22, and reserving a greater area on the inner wall 21 and the outer wall 22 for setting the through holes for sound emission or pressure relief. Furthermore, the flexible portion is disposed at the position between the inner wall 21 and the outer wall 22 without increasing a thickness of the earphone, thereby making the earphone more compact and aesthetically pleasing.

The flexible portion is connected to the housing portion 20. The outer surface of the flexible portion forms a portion of the side face of the earphone 100. The flexible portion is installed at a position of the first opening 20b of the housing portion 20. The flexible portion covers the first opening 20b and is connected to the housing portion 20. The flexible portion and the housing portion 20 enclose the accommodation cavity 20a in the housing portion 20. Setting the flexible portion as a flexible wall structure of the housing portion 20 allows the first opening 20b to be provided on the housing portion 20. The first opening 20b has a sufficient opening size. The first opening 20b may also allow the speaker 50 to be inserted and installed into the accommodation cavity 20a, thereby facilitating the installation of the speaker 50. In some embodiments, the flexible portion is disposed on and covers the side wall of the housing portion 20. In the wearing state of the earphone, the earphone also abuts against the cavum conchae wall through the flexible portion, thereby improving the wearing comfort.

Specifically, the flexible portion is located at one end of the housing portion 20 in the long axis direction. The flexible portion serves as a back wall of the housing portion 20 (a wall facing a back direction of the human body in the wearing state). In the wearing state of the earphone, the flexible portion abuts against the cavum conchae wall from front to back.

One end of the flexible portion (a lower end in the wearing state) may extend to be aligned or flush with the lower wall 24 of the housing portion 20. The flexible portion does not cover the lower wall 24 of the housing portion 20. As there is a second gap space B between a portion of the lower wall 24 of the housing portion 20 near the flexible portion and the cavum conchae for communicating with the external ear canal in the wearing state of the earphone, and the second gap space B is relatively small, the flexible portion does not extend to cover the lower wall 24 of the housing portion 20, to prevent the flexible portion from blocking or reducing the second gap space B. The flexible portion not covering the lower wall 24 of the housing portion 20 ensures the wearing comfort of the open earphone, and ensures a sufficient openness of the open earphone.

In some embodiments, while ensuring that the earphone is in an open state, one end of the flexible portion (the lower end in the wearing state) also extends to the lower wall 24 of the housing portion 20.

The other end of the flexible portion (the upper end in the wearing state) may extend to be aligned or flush with the upper wall 23 of the housing portion 20. The end of the flexible portion (the upper end in the wearing state) may extend to form a portion of an upper side face of the earphone 100. Alternatively, the other end of the flexible portion (the upper end in the wearing state) may extend to cover a portion of the upper wall 23 of the housing portion 20. The portion of the upper side face of the earphone 100 refers to a portion of the side face of the earphone 100 facing upward in the wearing state. As there is a first gap space A between the upper wall 23 of the housing portion 20 and the cavum conchae for communicating with the external ear canal in the wearing state of the earphone, the first gap space A is relatively great, and a length of the first gap space A in the long axis direction is greater than a length of the second gap space B, a portion of the flexible portion may extend along the long axis direction to the upper wall 23 without blocking the first gap space A. Furthermore, the reduction of a portion of the first gap space A does not affect the openness of the earphone.

Referring to FIG. 3 and FIG. 4, in some embodiments, a central axis plane of the flexible portion in the thickness direction coincides with a central axis plane of the housing portion 20 in the thickness direction, the flexible portion is aligned with a middle portion of the housing portion 20 in the thickness direction, and the flexible portion is centered relative to the housing portion 20 in a front-back direction, so that the flexible portion and the housing portion 20 have a stronger sense of integration and better aesthetics after the flexible portion and the housing portion 20 are connected. In some embodiments, the flexible portion is connected between the outer wall 22 and the inner wall 21, and inner and outer side edges of the flexible portion are respectively aligned and connected with edges of the outer wall 22 and the inner wall 21. In the wearing state, the flexible portion does not form additional protrusions inward or outward, which improves the wearing comfort.

Referring to FIG. 3 and FIG. 4, in some embodiments, the outer surface of the flexible portion protrudes beyond the outer surface of the housing portion 20. An entire outer surface of the flexible portion protrudes beyond the outer surface of the housing portion 20. In the wearing state of the earphone, the outer surface of the flexible portion more easily contacts the cavum conchae wall, and the protruding flexible portion has a greater allowance for elastic deformation. Accordingly, after the earphone is worn and squeezed, the protruding flexible portion also prevents the outer surface of the housing portion 20 from contacting the cavum conchae wall, to allow only the elastic and soft flexible portion to contact the human body in the wearing state of the earphone, thereby providing a better wearing comfort. Certainly, a portion of the outer surface of the flexible portion protruding beyond an outer surface of the housing portion 20 may also prevent the outer surface of the housing portion 20 from contacting the cavum conchae wall in the wearing state of the earphone, which improves the wearing comfort.

A cross-section of the protruding flexible portion in a width direction may be a semicircular or elliptical structure. A middle portion of the flexible portion with the semicircular or elliptical cross-section protrudes, and protrusion heights of two sides gradually decrease and the flexible portion extends to connect with the inner wall 21 and the outer wall 22 of the housing portion 20. The protruding middle portion ensures that the flexible portion can be provided with the flexible material for cushioning to improve the wearing comfort. The gentle transition of the two sides to connect with the inner wall 21 and the outer wall 22 is more aesthetically pleasing.

The flexible portion may be a strip or belt structure. The flexible portion extends along a side face of the housing portion 20. Specifically, the flexible portion may extend from the back wall of the housing portion 20 to the upper wall. A width of the flexible portion may be equal to or slightly less than a width of the housing portion 20. The flexible portion does not protrude beyond the inner wall 21 and the outer wall 22 of the housing portion 20.

Referring to FIGS. 6-8, in some embodiments, the flexible portion only includes a first flexible section 11 and a second flexible section 12 connected with each other. The first flexible section 11 and the second flexible section 12 form an L-shaped or C-shaped structure. The first flexible section 11 and the second flexible section 12 are connected to form two adjacent side walls of the housing portion 20. The first flexible section 11 is connected to one end of the housing portion 20 in the long axis direction. The first flexible section 11 forms the back wall of the housing portion 20. The second flexible section 12 is connected to the upper wall 23 of the housing portion 20 facing upward in the short axis direction in the wearing state. The second flexible section 12 forms a portion of the upper wall of the housing portion 20.

The first flexible section 11 is mainly used for abutting against the cavum conchae wall. The second flexible section 12, which is an additional extension of the flexible portion, may wrap around a side wall corner of the earphone. The side wall corner abuts against the cavum conchae wall. In the wearing state of the earphone, a portion of the second flexible section 12 near the first flexible section 11 also abuts against the cavum conchae wall. With such an arrangement, the first flexible section 11 and the second flexible section 12 may completely cover a contact surface between the earphone and the cavum conchae wall in the wearing state, thereby increasing an area where the flexible portion abuts against the cavum conchae wall, and further improving wearing comfort.

The second flexible section 12 may be used to accommodate and install electronic components, and expand a functionality of the earphone. For example, an end of the second flexible section 12 away from the first flexible section 11 is provided with a mounting cavity 121 and a sound pickup hole 122. The mounting cavity 121 may be a groove provided on an inner wall of the second flexible section 12 facing the housing portion 20. The sound pickup hole 122 is disposed between the mounting cavity 121 and an outer wall of the first flexible section 11. The sound pickup hole 122 connects the mounting cavity 121 to an exterior of the earphone. A first sound pickup device 13 is installed in the mounting cavity 121. A sound pickup portion of the first sound pickup device 13 is aligned with the sound pickup hole 122, allowing the first sound pickup device 13 to collect sound from the exterior of the earphone through the sound pickup hole 122. The first sound pickup device 13 may be a microphone (mic) or other sound pickup devices.

The second flexible section 12 may include a first portion near the first flexible section 11 and a second portion away from the first flexible section 11. The first portion and the second portion are an integrated structure and may have no physical dividing line. One end of the first portion is near the first flexible section 11 and is connected to the first flexible section 11. The other end of the first portion away from the first flexible section 11 is connected to the second portion. A portion abutting against the cavum conchae wall in the wearing state of the earphone may be defined as the first portion. A portion not abutting against the cavum conchae wall in the wearing state of the earphone may be defined as the second portion. The mounting cavity 121 and the sound pickup hole 122 are disposed in the second portion, so that the sound pickup hole 122 is not blocked in the wearing state of the earphone. The first sound pickup device 13 in the mounting cavity 121 may collect sound from the exterior of the earphone through the sound pickup hole 122.

In some embodiments, the first flexible section 11 and the second flexible section 12 are an integrated structure formed integrally from the same material. For example, outer sides of the first flexible section 11 and the second flexible section 12 are integrally injection-molded from a soft material such as silicone. The integrally formed first flexible section 11 and second flexible section 12 have a better elastic deformation effect. Particularly, there is no gap at a turning connection between the first flexible section 11 and the second flexible section 12, to ensure an elastic deformation effect at the turning connection and provide a better wearing comfort experience.

The first flexible section 11 and the second flexible section 12 may also be fixedly connected by means such as bonding or snap-fitting, and also form a stable connection structure.

In some embodiments, the second flexible section 12 has a preset length. For example, a length of the second flexible section 12 in the long axis direction does not exceed half of a length of the housing portion 20 in the long axis direction. The length of the second flexible section 12 in the long axis direction is less than or equal to half of the length of the housing portion 20 in the long axis direction. In this way, it is ensured that the second flexible section 12 does not block the first gap space A, and the openness of the upper side of the earphone in the wearing state is ensured.

In some embodiments, the flexible portion only includes the first flexible section 11 and the first portion of the second flexible section 12, and does not include the second portion of the second flexible section 12. Positions and structures of the first flexible section 11 and the first portion of the second flexible section 12 are the same as those in the above-described embodiment. The first flexible section 11 and the first portion of the second flexible section 12 cover almost an entire contact surface that contacts the cavum conchae wall in the wearing state of the earphone. In the wearing state of the earphone, the earphone abuts against the cavum conchae wall through the first flexible section 11 and the first portion of the second flexible section 12, which also ensures the comfort in the wearing state.

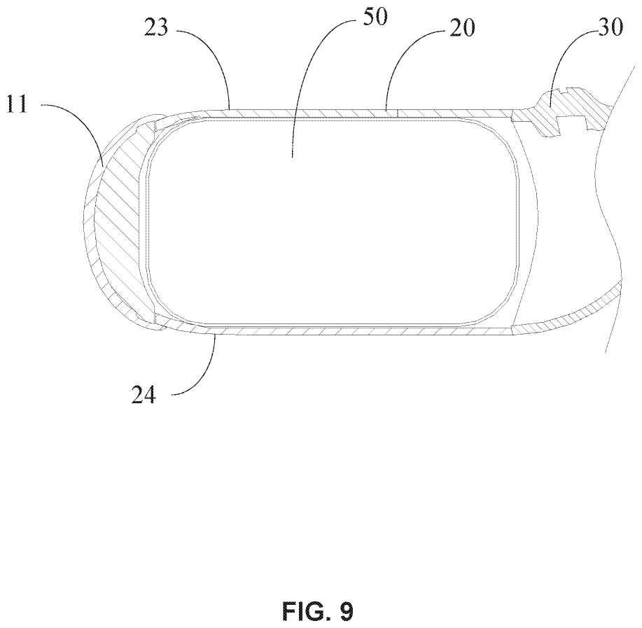

Referring to FIG. 9, in some embodiments, the flexible portion only includes the first flexible section 11 and does not include the second flexible section 12. A position and a structure of the first flexible section 11 are the same as the position and the structure in the above-described embodiment. The first flexible section 11 covers a majority of the contact surface that contacts the cavum conchae wall in the wearing state of the earphone. That is, in the wearing state of the earphone, a majority of the earphone abuts against the cavum conchae wall through the first flexible section 11, which also improves the comfort in the wearing state.

Referring to FIG. 6 to FIG. 8, in some embodiments, the flexible portion is a multi-layer structure. The flexible portion at least includes a contact layer 10a. The contact layer 10a is located at an outermost layer of the flexible portion. A Shore hardness of the contact layer 10a is less than a Shore hardness of the housing portion 20. The contact layer 10a may be made of materials with a good soft elasticity, such as silicone, latex, etc. In the wearing state of the earphone, the contact layer 10a contacts the cavum conchae wall. The soft contact layer 10a may deform according to a surface of the cavum conchae wall to contact the cavum conchae wall, which increases the contact area with the cavum conchae wall and improves the comfort in the wearing state of the earphone.

The flexible portion may further include a lining layer 10b. The lining layer 10b is located at an inner side of the flexible portion. The contact layer 10a wraps an outer side of the lining layer 10b. The Shore hardness of the contact layer 10a is less than a Shore hardness of the lining layer 10b. The lining layer 10b may be made of hard materials, such as plastic, rubber, metal, etc. The lining layer 10b and the housing portion 20 are fixedly connected by snap-fit, adhesion, etc. The contact layer 10a may be formed on or fixed to the outer side of the lining layer 10b by injection molding, adhesion, etc. The flexible portion includes the contact layer 10a and the lining layer 10b, which forms a double-layer structure that is hard inside and soft outside. The inner lining layer 10b plays a role in installation, connection, support, and shaping. The outer contact layer 10a plays a role in elastic contact with the human body.

The flexible portion may further include a structure composed of more layers or more components. For example, the flexible portion is also configured as a three-layer structure. A hardness of the three-layer structure from inside to outside decreases sequentially. A transition layer is formed between double layers of a flexibility layer and a rigidity layer, which improves the wearing comfort and avoids the innermost hardest structure from pressing against the human body in the wearing state.

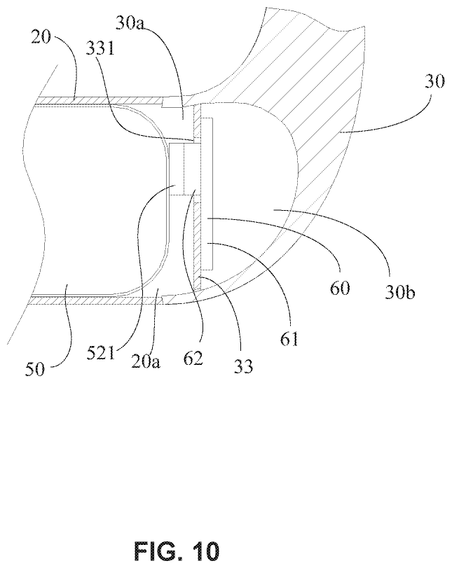

Referring to FIGS. 10-15, in one embodiment, two mutually independent adapter cavities are provided in the adapter portion 30. A circuit board assembly 60 is installed in the adapter cavity of the adapter portion 30.

The circuit board assembly 60 and other components may be disposed in a receiving cavity of the adapter portion 30, which optimizes a utilization of an internal space of the earphone, improves a space utilization of the earphone, and reduces a volume of the earphone. Furthermore, the two mutually independent adapter cavities are provided in the adapter portion 30, which allows components in the adapter housing and the speaker 50 in the housing portion 20 to be installed separately, to avoid or reduce an electromagnetic interference that the components such as the circuit board assembly 60 may generate on the speaker 50. Furthermore, the circuit board assembly 60 is installed in the adapter cavity of the adapter portion 30. The mutually independent adapter cavities may be sealed more easily and conveniently, thereby more conveniently providing a sealed protection for the components such as the circuit board assembly 60 in the adapter cavity.

The two mutually independent adapter cavities are provided in the adapter portion 30, which also allows the components in the adapter housing and the speaker 50 in the housing portion 20 to be installed separately. In this way, the electromagnetic interference generated by the components such as the circuit board assembly 60 on the speaker 50 may be avoided or reduced.

Specifically, the adapter portion 30 has the receiving cavity and a separator 33 is installed in the receiving cavity. The separator 33 divides the receiving cavity into a first adapter cavity 30a and a second adapter cavity 30b. Furthermore, the separator 33 is sealedly connected to an inner wall of the adapter portion 30, so that the first adapter cavity 30a and the second adapter cavity 30b are completely separated. The separator 33 may also provide functions for water isolation and waterproofing.

The adapter portion 30 has a shape that is greater at one end and smaller at the other end. The greater end of the adapter portion 30 is connected to the housing portion 20. The smaller end of the adapter portion 30 is connected to the earhook portion 40. The first adapter cavity 30a and the second adapter cavity 30b may be distributed sequentially along a direction from the greater end towards the smaller end of the adapter portion 30. For example, the first adapter cavity 30a is closer to the greater end of the adapter portion 30, and the second adapter cavity 30b is farther from the greater end of the adapter portion 30. That is, the first adapter cavity 30a is located at the end of the adapter portion 30 close to the housing portion 20, and the second adapter cavity 30b is located at the end of the adapter portion 30 far from the housing portion 20.

The first adapter cavity 30a may further communicate with the accommodation cavity 20a of the housing portion 20. An opening is provided at the end of the adapter portion 30 close to the housing portion 20, and the opening of the adapter portion 30 communicates with the first adapter cavity 30a. The opening of the adapter portion 30 and the second opening 20c of the housing portion 20 are complementarily adapted. After the adapter portion 30 is connected to the housing portion 20, the first adapter cavity 30a and the accommodation cavity 20a communicate to form one cavity. With such a layout, the second adapter cavity 30b is separated from the accommodation cavity 20a. The components may be installed in the second adapter cavity 30b, so that the components and the speaker 50 are installed separately. Meanwhile, the second adapter cavity 30b forms a sealed cavity, which provides a sealed and waterproof protection for the components in the second adapter cavity 30b.

The first adapter cavity 30a and the second adapter cavity 30b may also adopt other layout manners. For example, the first adapter cavity 30a and the second adapter cavity 30b are arranged in upper and lower layers. Both the first adapter cavity 30a and the second adapter cavity 30b extend from the greater end to the smaller end of the adapter portion 30. Such a layout may facilitate the installation of components in the first adapter cavity 30a and the second adapter cavity 30b. Furthermore, the components installed in the first adapter cavity 30a and the second adapter cavity 30b may be separated, which facilitates the sealing of partial structures and reduces mutual interference between the components installed in the first adapter cavity 30a and the second adapter cavity 30b.

In some embodiments of the present disclosure, the circuit board assembly 60 is installed in the second adapter cavity 30b. The circuit board assembly 60 is electrically connected to the speaker 50. The circuit board assembly 60 and the speaker 50 are separated by the separator 33, which reduces a mutual electromagnetic interference between the circuit board assembly 60 and the speaker 50. The circuit board assembly 60 is located in the sealed second adapter cavity 30b, which prevents external moisture from entering the second adapter cavity 30b and avoids or reduces a risk of damage such as short circuits due to dampness of the circuit board assembly 60.

To achieve an electrical connection between the circuit board assembly 60 and the speaker 50, the separator 33 is provided with a mounting hole 331. The mounting hole 331 penetrates the separator 33. The circuit board assembly 60 includes a circuit board 61 and a first electrical connection terminal 62. The circuit board 61 may be installed to abut against the separator 33. An area of the circuit board 61 is greater than an opening area of the mounting hole 331. The circuit board 61 seals the mounting hole 331. Viewed from a side of the first adapter cavity 30a, a portion of the circuit board 61 is exposed through the mounting hole 331. The first electrical connection terminal 62 is installed on a region of the circuit board 61 exposed through the mounting hole 331. That is, all or a portion of the first electrical connection terminal 62 is located within the mounting hole 331. That is, the first electrical connection terminal 62 is located in the first adapter cavity 30a. The first electrical connection terminal 62, as portion of the circuit board assembly 60, extends into the first adapter cavity 30a to achieve the electrical connection with the speaker 50, while a main body portion (i.e., the circuit board 61) of the circuit board assembly 60 is separated at the first adapter cavity 30a. This structural arrangement achieves the electrical connection between the circuit board assembly 60 and the speaker 50, while the main body portion of the circuit board assembly 60 is separated from the speaker 50.

The first electrical connection terminal 62 may be a first plug-in terminal. The speaker 50 is connected to the flexible circuit board. A second electrical connection terminal 521 is provided at one end of the flexible circuit board. The second electrical connection terminal 521 may be a second plug-in terminal. One of the first plug-in terminal and the second plug-in terminal may be a socket terminal, and the other may be a plug terminal. The first plug-in terminal is directly fixed to the circuit board 61 by welding etc. The plug terminal and the socket terminal are plugged together to form the electrical connection. Using the connection manner of the socket terminal and the plug-in terminal, before the housing portion 20 and the adapter portion 30 are docked and installed, the electrical connection between the speaker 50 and the circuit board assembly 60 is quickly completed through plugging, which facilitates assembly. Further, subsequent disassembly and maintenance are convenient.

The speaker 50 and the circuit board assembly 60 may also be electrically connected in other ways. The first electrical connection terminal 62 itself is a flexible circuit board that extends into the accommodation cavity 20a to be electrically connected to the speaker 50 or to the flexible circuit board connected to the speaker 50. This manner may also achieve the electrical connection between the speaker 50 and the circuit board assembly 60.

In some embodiments, a size of the mounting hole 331 matches the first electrical connection terminal 62. The first electrical connection terminal 62 is inserted into the mounting hole 331, to achieve an extension from the second adapter cavity 30b to the first adapter cavity 30a. Furthermore, the first electrical connection terminal 62 may also block the mounting hole 331. With such a configuration, the first electrical connection terminal 62 is used to block the mounting hole 331. The circuit board 61 may be installed at other positions within the second adapter cavity 30b to satisfy layout requirements of other components.

In some embodiments, the separator 33 is a partition plate. The separator 33 is a plate structure, which can be simplified. Meanwhile, both sides of the plate structure are planar. When the circuit board 61 is installed on a side of the separator 33 facing the second adapter cavity 30b, the circuit board 61 may be parallel to and attached to the separator 33, so that the circuit board 61 blocks the mounting hole 331 of the separator 33.

The separator 33 is an integrally formed partition plate, which can eliminate splicing gaps on the partition plate and improve the sealing and waterproofing effects.

The separator 33 may also be other structures. For example, the mounting hole 331 on the partition plate facing the second adapter cavity 30b is surrounded by an annular plane. The annular plane may be a plane of an annular protrusion surrounding the mounting hole 331 and facing away from a surface of the separator 33. Alternatively, the annular plane may be a bottom surface of an annular groove recessed around the mounting hole 331. Alternatively, the annular plane may be a plane recessed around the mounting hole 331. Other portions of the partition plate may be planar, sloped, curved, or combinations thereof. In this structure, the circuit board 61 abuts against the annular plane surrounding the mounting hole 331, which also blocks the mounting hole 331 to isolate the first adapter cavity 30a from the second adapter cavity 30b.

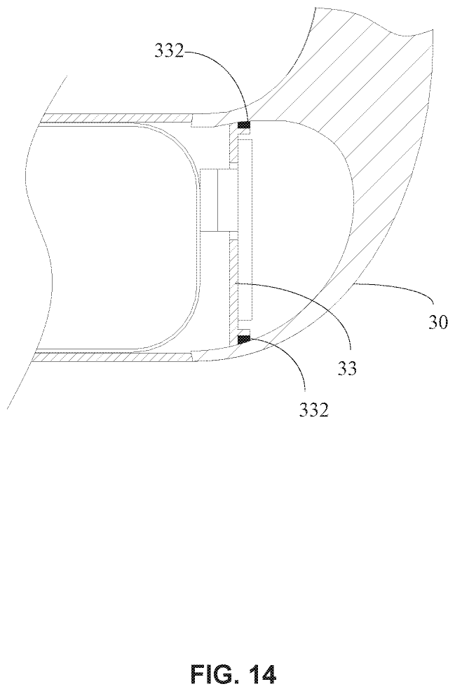

Referring to FIG. 14, a peripheral edge of the partition plate is hermetically connected to the inner wall of the adapter portion 30 to prevent the moisture from entering the first adapter cavity 30a or the second adapter cavity 30b through a connection between the partition plate and the inner wall of the adapter portion 30.

Protrusions are provided on the peripheral edge of the partition plate, or grooves are provided on an inner sidewall of the adapter portion 30. The partition plate and the inner sidewall of the adapter portion 30 form a second adhesive accommodation groove 332. The second adhesive accommodation groove 332 is filled with an adhesive. The second adhesive accommodation groove 332 is jointly enclosed by the partition plate and the inner sidewall of the adapter portion 30, so that the adhesive contacts and connects with both the partition plate and the inner sidewall of the adapter portion 30 to achieve the sealing of the connection between the partition plate and the inner sidewall of the adapter portion 30. The second adhesive accommodation groove 332 is disposed on a side of the second adapter cavity 30b, so that after the partition plate is installed into the adapter portion 30, the partition plate isolates the adhesive within the second adapter cavity 30b. The second adhesive accommodation groove 332 and the adhesive do not occupy space of the first adapter cavity 30a, which is beneficial for installing the speaker 50 with a greater size. Meanwhile, isolating the adhesive within the sealed second adapter cavity 30b may reduce the interference by factors such as a vibration of the speaker 50, and improve a stability of the adhesive sealing. Certainly, the second adhesive accommodation groove 332 and the adhesive may also be disposed on a side of the first adapter cavity 30a, which also achieves the sealing of the connection between the partition plate and the inner wall of the adapter portion 30.

Other structures or components may also be provided between the peripheral edge of the partition plate and the inner wall of the adapter portion 30 for sealing. For example, an annular step is provided in the accommodation cavity of the adapter portion 30. The annular step faces the opening of the adapter portion 30 toward the housing portion 20. The partition plate is installed onto the annular step in the adapter portion 30. The peripheral edge of the partition plate is attached to the annular step in the adapter portion 30 for installation. In this connection structure, adding the adhesive between the partition plate and the annular step may achieve a sealed connection between the partition plate and the adapter portion 30.

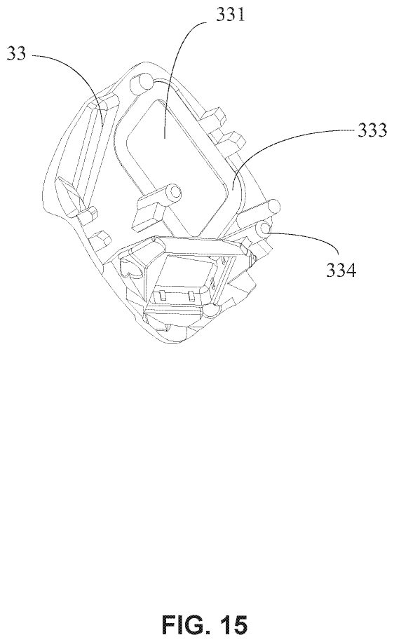

Referring to FIG. 15, in some embodiments, a sealing member 333 is provided between the separator 33 and the circuit board 61. For example, an annular groove surrounding the mounting hole 331 is provided on a side of the separator 33 facing the circuit board 61. The sealing member 333 is installed in the annular groove. After the circuit board 61 is fitted to the separator 33 for installation, the sealing member 333 forms a seal for the mounting hole 331 to separate the mounting hole 331 from the second adapter cavity 30b. The provision of the sealing member 333 may further improve a waterproof sealing effect at the mounting hole 331. The provision of the annular groove may facilitate installation and fixation of the sealing member 333, avoid a misalignment movement of the sealing member 333, and improve a waterproof stability of the sealing member 333. In the present disclosure, the sealing member 333 is an annular adhesive strip or a waterproof foam adhesive adapted to the annular groove. The sealing member 333 seals the mounting hole 331 and fixes the circuit board 61 to the separator 33.

The separator 33 may also not include the annular groove. The sealing member 333 may be directly disposed between the circuit board 61 and the separator 33 and surround the mounting hole 331. The sealing member 333 may also seal the mounting hole 331. For example, the sealing member 333 is an adhesive. The adhesive is directly applied to the circuit board 61 and/or the separator 33. After the circuit board 61 and the separator 33 are attached and installed, the adhesive achieves adhesive fixation and sealing.

Referring to FIG. 15, in some embodiments, the separator 33 also serves a mounting function, or the separator 33 is understood as a portion of a mounting member. The separator 33 is configured to separate the first adapter cavity 30a and the second adapter cavity 30b. The separator 33 is also configured to mount the circuit board 61. Such an arrangement may simplify the structure in the adapter portion 30. The circuit board assembly 60 and the separator 33 may be installed as an integrated structure and then installed together into the adapter portion 30, thereby optimizing installation steps and improving installation efficiency. The arrangement may also avoid installing the circuit board 61 into the adapter portion 30, thereby reducing the installation difficulty.

A mounting portion 334 is provided at an end of the separator 33 facing the second adapter cavity 30b. The mounting portion 334 may be a protruding mounting column or other mounting structures. The circuit board 61 may be fixedly connected to the mounting portion 334 by means of screws, snap-fitting, welding, bonding or by fusing the installation column, etc., thereby positioning and mounting the circuit board 61 on the separator 33.

In some embodiments, other mounting structures are also provided in the adapter portion 30 to mount and fix the circuit board assembly 60. For example, a protruding mounting column or other structures may be provided on the inner wall of the adapter portion 30. The mounting column may also achieve positioning, mounting, and fixation of the circuit board 61.

In some embodiments, the circuit board assembly 60 is installed in the first adapter cavity 30a. The circuit board assembly 60 and the speaker 50 are located in the same cavity, which simplifies the connection between the circuit board assembly 60 and the speaker 50. At the same time, more space is freed up in the second adapter cavity 30b to install other electronic components, thereby achieving separation and protection for the other electronic components.

In some embodiments, the separator 33 is not provided in the adapter portion 30. The circuit board 61 of the circuit board assembly 60 serves as the separator to separate the accommodation cavity into the first adapter cavity 30a and the second adapter cavity 30b. The first electrical connection terminal 62 is disposed on a side of the circuit board 61 facing the first adapter cavity 30a. Other electronic components are disposed in the second adapter cavity 30b and are electrically connected to the circuit board 61. In this way, a relatively independent second adapter cavity 30b is formed, thereby isolating and protecting the other electronic components.

In some embodiments, the circuit board assembly 60 also includes other components to expand other functions of the earphone. For example, the earphone also includes a second sound pickup device and a battery circuit. The circuit board 61 includes a first electrical connection portion, a second electrical connection portion, and a third electrical connection portion. The first electrical connection portion is electrically connected to the first electrical connection terminal 62. The second electrical connection portion is electrically connected to the second sound pickup device. The third electrical connection portion is electrically connected to the battery circuit. The first electrical connection portion, the second electrical connection portion, and the third electrical connection portion are electrically connected to the first electrical connection terminal 62, the second sound pickup device, and the battery circuit, respectively, by welding. The earphone also has functions such as sound pickup.

The circuit board 61 may be a flexible circuit board. The circuit board 61 may be bent along a curve to be electrically connected to the first electrical connection terminal 62, the second sound pickup device, and the battery circuit located at different spatial positions.

The second sound pickup device may be a microphone (mic) or other sound pickup devices. The adapter portion 30 includes a mounting hole penetrating the adapter portion 30. The second sound pickup device is installed in a housing with a sound pickup hole. The housing is fixed in the mounting hole of the adapter portion 30. In this way, the second sound pickup device is embedded into the housing of the adapter portion 30 to reduce the space occupied in the second adapter cavity 30b. The adapter portion 30 may also include a sound pickup hole penetrating the adapter portion 30. The second sound pickup device is located in the adapter portion 30 and is aligned with the sound pickup hole. In this way, a reception of sound from the outside of the earphone is achieved.

In some embodiments, the circuit board 61 is a flexible circuit board. Hard structural plates, such as steel plates or other metal plates, are respectively installed and fixed at solder joint positions such as the first electrical connection portion, the second electrical connection portion, and the third electrical connection portion of the circuit board 61. The hard structural plates may improve a structural stability of the flexible circuit board at the solder joint positions such as the first electrical connection portion, the second electrical connection portion, and the third electrical connection portion, thereby ensuring a welding stability at the solder joint positions such as the first electrical connection portion, the second electrical connection portion, and the third electrical connection portion.

The above description applies specific examples to illustrate the present disclosure, which is only intended to help understand the present disclosure and does not limit the present disclosure. For those skilled in the art of the present disclosure, based on the ideas of the present disclosure, several simple deductions, modifications, or replacements may also be made.

1. An earphone, comprising a flexible portion, a housing portion, an earhook portion, and a speaker, wherein
the housing portion has an accommodation cavity, wherein the speaker is disposed in the accommodation cavity;
the flexible portion is connected to one end of the housing portion, and the earhook portion is connected to the other end of the housing portion; and
the earphone comprises an inner face facing a user, an outer face facing away from the user in a wearing state, and a side face connecting the inner face and the outer face, wherein the flexible portion is located at the side face, and at least a portion of the flexible portion abuts against a cavum conchae wall in the wearing state.

2. The earphone of claim 1, wherein the housing portion has a long axis direction, a short axis direction, and a thickness direction perpendicular to each other, the thickness direction being parallel to a vibration direction of the speaker, wherein
the flexible portion is disposed at one end of the housing portion in the long axis direction, and the earhook portion is connected to the other end of the housing portion in the long axis direction away from the flexible portion;
a first gap space communicating with an external ear canal is formed between an upper side of the housing portion and the cavum conchae wall in the wearing state, and a second gap space communicating with the external ear canal is formed between a lower side of the housing portion and the cavum conchae wall in the wearing state, wherein the first gap space and the second gap space are respectively located on two sides of the housing portion in the short axis direction.

3. The earphone of claim 2, wherein a central axis plane of the flexible portion in the thickness direction coincides with a central axis plane of the housing portion in the thickness direction.

4. The earphone of claim 2, wherein the flexible portion includes a first flexible section, wherein the first flexible section is connected to the end of the housing portion in the long axis direction.

5. The earphone of claim 2, wherein the flexible portion includes a first flexible section and a second flexible section connected to each other, wherein
the first flexible section is connected to the end of the housing portion in the long axis direction; and
the second flexible section is connected to an upper wall of the housing portion in the short axis direction upward in the wearing state.

6. The earphone of claim 4, wherein one end of the first flexible section extends to be aligned or flush with a lower wall of the housing portion in the short axis direction downward in the wearing state.

7. The earphone of claim 5, wherein a length of the second flexible section is less than or equal to half of a length of the housing portion in the short axis direction.

8. The earphone of claim 5, wherein the second flexible section includes a first portion close to the first flexible section and a second portion away from the first flexible section, wherein in the wearing state, the first portion abuts against the cavum conchae wall, and a gap is formed between the second portion and the cavum conchae wall.

9. The earphone of claim 8, wherein the second portion is provided with a mounting cavity and a sound pickup hole, wherein the mounting cavity is in communication with an outside of the earphone through the sound pickup hole, and a sound pickup device is installed in the mounting cavity.

10. The earphone of claim 5, wherein
the first flexible section and the second flexible section are an integrated structure.

11. The earphone of claim 1, wherein the housing portion includes an inner wall facing an ear, an outer wall facing away from the ear, an upper wall facing upward, and a lower wall facing downward in the wearing state along the vibration direction of the speaker, wherein
an outer surface of the flexible portion protrudes from the upper wall and/or the lower wall of the housing portion.

12. The earphone of claim 11, wherein the flexible portion at least includes a contact layer, wherein a Shore hardness of the contact layer is less than a Shore hardness of the housing portion, and at least a portion of the contact layer abuts against the cavum conchae wall in the wearing state.

13. The earphone of claim 12, wherein the flexible portion further includes a lining layer, wherein
the contact layer wraps an outer side of the lining layer;
the lining layer is connected to the housing portion; and
the Shore hardness of the contact layer is less than a Shore hardness of the lining layer.

14. The earphone of claim 11, wherein the flexible portion is a strip structure or a belt structure.

15. The earphone of claim 1, wherein a first opening in communication with the accommodation cavity is provided at an end of the housing portion away from the earhook portion, and the flexible portion covers the first opening and is connected to the housing portion.

16. The earphone of claim 15, wherein an opening size of the first opening allows the speaker to be inserted and installed into the accommodation cavity.

17. The earphone of claim 1, further comprising an adapter portion, wherein the adapter portion is located between the housing portion and the earhook portion, and the housing portion is connected to the earhook portion through the adapter portion.

18. The earphone of claim 5, wherein
the first flexible section and the second flexible section are connected to form a C-shaped structure or an L-shaped structure.

19. The earphone of claim 11, wherein the outer surface of the flexible portion is not coplanar with the inner wall and/or the outer wall of the housing portion.

20. The earphone of claim 14, wherein a cross-section of the flexible portion in a width direction is a semicircular structure or a semi-elliptical structure.
